(19) United States
(12) Patent Application Publication
(10) Pub. No.: US 2026/0339319 A1
(43) Pub. Date: Oct. 29, 2026

(54) Web-Based Drone Control Interface With Augmented Reality Overlays

(71) Applicant: Skydio, Inc., San Mateo, CA (US)

(72) Inventors: Divyanshu Pachisia, San Francisco, CA (US); Kristen Marie Holtz, Menlo Park, CA (US); Charles VanSchoonhoven Wood, Cazenovia, NY (US); Rebecca Asdoorian, San Mateo, CA (US); Clara Kelley, Half Moon Bay, CA (US)

(21) Appl. No.: 19/656,237

(22) Filed: Apr. 23, 2026

Related U.S. Application Data
(60) Provisional application No. 63/793,057, filed on Apr. 23, 2025.

(51) Int. Cl. G05D 1/223; G05D 1/224; G05D 109/20

(52) U.S. Cl. CPC G05D 1/223; G05D 1/2249; G05D 2109/20

(57) ABSTRACT

A system for precision teleoperation of an unmanned aerial vehicle (UAV) includes an operator station executing a browser application. The operator station includes a live video renderer displaying video frames from the UAV within a video viewport, an overlay renderer rendering within the video viewport a current-state marker representing a current UAV position or viewing state derived from received telemetry and a commanded-state marker representing an intended position or viewing state selected by an operator, an input handling subsystem receiving input events from at least one of a keyboard input device or pointing input device, and a command generation subsystem generating stepwise position commands based on the received input events for transmission to the UAV. The overlay renderer renders the current-state marker and commanded-state marker such that spatial separation between the markers indicates a lag condition between a reported UAV state and commanded UAV state.

### CROSS-REFERENCE TO RELATED APPLICATIONS

This claims priority to and benefit from U.S. Provisional Patent Application No. 63/793,057, filed on Apr. 23, 2025 titled “WEB-BASED DRONE CONTROL INTERFACE WITH AUGMENTED REALITY OVERLAYS AND RELATED METHODS” which is expressly incorporated by reference herein.

### FIELD OF INVENTION

The present disclosure relates to web-based unmanned aerial vehicle control interfaces, and more particularly to a precision teleoperation system that utilizes augmented reality overlays and stepwise position-based commands for enhanced drone navigation and control in latency-affected environments.

### BACKGROUND

Unmanned aerial vehicles have become widely used across various industries, supporting applications that range from aerial photography and surveillance to infrastructure inspection and agricultural monitoring. The ability to control such vehicles with precision is valuable in many operational contexts, particularly in environments where accuracy and reliability may affect mission outcomes.

Remote control of unmanned aerial vehicles is often accomplished through video-based interfaces that present live imagery from onboard cameras to an operator at a ground station. In such arrangements, the operator issues control inputs based on the displayed video, and the vehicle responds accordingly. However, communication links between the operator station and the vehicle may introduce latency, such that video feedback and telemetry received by the operator represent a past state of the vehicle rather than an instantaneous state. Round-trip delays of up to several seconds may occur in some operating conditions, particularly in radio-frequency-congested environments or when operating at extended ranges.

Many existing drone control interfaces rely on velocity-based or rate-based commands, in which the duration or magnitude of an operator input is mapped to a corresponding velocity or rate of movement. While such interfaces may be intuitive in low-latency conditions, they can present challenges when communication delays are present. Under latency, the same input duration may produce different movement increments depending on timing and network conditions, potentially leading to inconsistent vehicle behavior. Operators may find it difficult to achieve precise positioning when the relationship between input duration and resulting displacement becomes unpredictable.

In high-latency environments, operators may adopt a slower operational cadence, issuing an input and then waiting for the vehicle to respond before issuing a subsequent input. This approach can reduce throughput and may still result in positioning errors when the operator cannot accurately predict the outcome of a given input. Tasks such as centering a feature within the video field or performing detailed asset inspections may become more challenging under such conditions.

As unmanned aerial vehicles are increasingly deployed for operations where positioning accuracy may affect safety or mission effectiveness, there is interest in control mechanisms that can accommodate latency while providing operators with predictable and consistent vehicle response. Improved approaches to operator feedback and command generation may help address some of the challenges associated with remote vehicle control in latency-affected environments.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a system for precision teleoperation of an unmanned aerial vehicle (UAV) is provided. The system includes an operator station configured to execute a browser application. The operator station includes a live video renderer configured to display video frames received from the UAV within a video viewport. The operator station includes an overlay renderer configured to render, within the video viewport, a current-state marker representing a current position or viewing state of the UAV derived from received telemetry, and a commanded-state marker representing an intended position or viewing state selected by an operator. The operator station includes an input handling subsystem configured to receive input events from at least one of a keyboard input device or a pointing input device. The operator station includes a command generation subsystem configured to generate stepwise position commands based on the received input events for transmission to the UAV. The overlay renderer is configured to render the current-state marker and the commanded-state marker such that spatial separation between the current-state marker and the commanded-state marker indicates a lag condition between a reported UAV state and a commanded UAV state.

According to other aspects of the present disclosure, the system may include one or more of the following features. The command generation subsystem may be configured to generate absolute-position-based commands rather than velocity-based commands. The input handling subsystem may be configured to discriminate between a tap input and a press input received from the keyboard input device, and the command generation subsystem may be configured to generate a fixed-distance movement command in response to the tap input. The system may further include a user settings store configured to store a user-selectable movement increment, and the command generation subsystem may be configured to compute the fixed-distance movement command based on the user-selectable movement increment. The overlay renderer may be further configured to render a preview overlay representing an intended movement before an associated command is transmitted to the UAV. The input handling subsystem may be configured to receive a double-click action from the pointing input device, and the command generation subsystem may be configured to generate a fixed-distance travel command in a direction indicated by the double-click action. The input handling subsystem may be further configured to receive a scroll input from the pointing input device, and the command generation subsystem may be configured to adjust a movement distance based on the scroll input. The current-state marker may be smaller than the commanded-state marker such that the operator can distinguish the current position from the intended position. The overlay renderer may be configured to render an aligned marker condition when the current-state marker and the commanded-state marker become substantially coincident, the aligned marker condition indicating that the UAV has reached the intended position.

According to another aspect of the present disclosure, a method for controlling an unmanned aerial vehicle (UAV) via a web-based interface is provided. The method includes receiving, at an operator station, live video and telemetry data from the UAV over a network link subject to a latency condition. The method includes rendering, within a video viewport displaying the live video, a current-state marker representing a current position of the UAV derived from the received telemetry data. The method includes receiving a user input event from at least one of a keyboard input device or a pointing input device. The method includes computing an intended endpoint based on the user input event. The method includes rendering, within the video viewport, a commanded-state marker representing the intended endpoint. The method includes transmitting a stepwise position command corresponding to the intended endpoint to the UAV. The method includes displaying spatial separation between the current-state marker and the commanded-state marker to indicate a lag condition until the current position converges to the intended endpoint.

According to other aspects of the present disclosure, the method may include one or more of the following features. The method may further include classifying the user input event as a tap input or a press input based on an input duration, and in response to classifying the user input event as the tap input, computing a fixed movement increment based on a stored user setting. The method may further include rendering a preview overlay showing the intended endpoint before transmitting the stepwise position command, and transmitting the stepwise position command in response to receiving a commit action. The method may further include receiving updated telemetry data from the UAV, evaluating whether a convergence condition has been satisfied between the current-state marker and the commanded-state marker, and in response to the convergence condition being satisfied, rendering an aligned marker condition indicating that the UAV has reached the intended endpoint. Receiving the user input event may include receiving a double-click action from the pointing input device, and computing the intended endpoint may include determining a fixed-distance travel in a direction indicated by the double-click action. The method may further include receiving a scroll input from the pointing input device and adjusting a movement distance associated with the intended endpoint based on the scroll input. The method may further include detecting a degraded link condition based on at least one of telemetry freshness, latency exceeding a threshold, or packet loss exceeding a threshold, and in response to detecting the degraded link condition, rendering a warning indicator within the video viewport.

According to another aspect of the present disclosure, a non-transitory computer-readable medium storing instructions that, when executed by a processor, cause the processor to perform operations is provided. The operations include receiving live video and telemetry data from an unmanned aerial vehicle (UAV) over a network link. The operations include rendering, within a video viewport displaying the live video, a current-state marker representing a current position of the UAV. The operations include receiving a user input event. The operations include computing an intended endpoint based on the user input event. The operations include rendering, within the video viewport, a commanded-state marker representing the intended endpoint, wherein the current-state marker and the commanded-state marker are rendered such that spatial separation between the markers indicates a lag condition. The operations include generating a stepwise position command corresponding to the intended endpoint. The operations include transmitting the stepwise position command to the UAV.

According to other aspects of the present disclosure, the operations may include one or more of the following features. The operations may further include discriminating between a tap input and a press input based on an input duration of the user input event, and in response to the user input event being classified as the tap input, computing a fixed movement increment based on a user-configurable distance setting. The operations may further include rendering a preview overlay representing the intended endpoint before the stepwise position command is transmitted, receiving updated telemetry data indicating an updated current position of the UAV, and rendering an aligned marker condition when the updated current position converges to the intended endpoint. The user input event may include a double-click action from a pointing input device, computing the intended endpoint may include determining a fixed-distance travel in a direction indicated by the double-click action, and the operations may further include adjusting a movement distance based on a scroll input received from the pointing input device.

According to another aspect of the present disclosure, a web-based drone control system is provided. The system includes a visual position indicator system configured to display a drone's future travel distance and final position in a 3D augmented reality environment before the drone executes a movement. The visual position indicator system includes a dual-circle indicator system including a smaller circle representing the drone's current position and a larger circle showing the drone's intended destination. The system includes a mouse-based control system configured to facilitate precise drone positioning despite latency. The mouse-based control system provides fine-tuning adjustments to the drone's position via scroll controls and fixed-distance travel in a direction indicated by a double-click action. The system includes a differentiated keyboard input system configured to initiate a drone movement of a fixed, adjustable distance in response to a keyboard tap. The system includes an absolute position-based interface configured to employ absolute position-based commands to control the drone.

According to other aspects of the present disclosure, the web-based drone control system may include one or more of the following features. The visual position indicator system may be configured to enhance spatial awareness and predictive control accuracy of the drone. The visual position indicator system may be configured to provide an augmented reality indication of where the drone is going to move in response to a particular user interaction. The mouse-based control system may be configured to provide precise drone positioning despite latency. The differentiated keyboard input system may be configured to enable predictable and precise increments of drone movement. The system may further include user-defined settings configured to define the fixed, adjustable distance for the keyboard tap. The absolute position-based interface may be configured to significantly improve reliability and predictability of drone control compared to velocity-based controls.

According to another aspect of the present disclosure, a method for controlling a drone using a web-based interface is provided. The method includes displaying, via a visual position indicator system, a drone's future travel distance and final position in a 3D augmented reality environment before the drone executes a movement. The visual position indicator system includes a dual-circle indicator system including a smaller circle representing the drone's current position and a larger circle showing the drone's intended destination. The method includes facilitating, via a mouse-based control system, precise drone positioning despite latency by providing fine-tuning adjustments to the drone's position via scroll controls and fixed-distance travel in a direction indicated by a double-click action. The method includes initiating, via a differentiated keyboard input system, a drone movement of a fixed, adjustable distance in response to a keyboard tap. The method includes employing, via an absolute position-based interface, absolute position-based commands to control the drone.

According to other aspects of the present disclosure, the method may include one or more of the following features. The method may further include enhancing spatial awareness and predictive control accuracy of the drone via the visual position indicator system. The method may further include providing, via the visual position indicator system, an augmented reality indication of where the drone is going to move in response to a particular user interaction. The method may further include providing, via the mouse-based control system, precise drone positioning despite latency. The method may further include enabling, via the differentiated keyboard input system, predictable and precise increments of drone movement. The method may further include defining, via user-defined settings, the fixed, adjustable distance for the keyboard tap. The method may further include significantly improving, via the absolute position-based interface, reliability and predictability of drone control compared to velocity-based controls.

According to another aspect of the present disclosure, a non-transitory computer-readable medium storing instructions that, when executed by a processor, cause the processor to perform operations for controlling a drone using a web-based interface is provided. The operations include displaying, via a visual position indicator system, a drone's future travel distance and final position in a 3D augmented reality environment before the drone executes a movement. The visual position indicator system includes a dual-circle indicator system including a smaller circle representing the drone's current position and a larger circle showing the drone's intended destination. The operations include facilitating, via a mouse-based control system, precise drone positioning despite latency by providing fine-tuning adjustments to the drone's position via scroll controls and fixed-distance travel in a direction indicated by a double-click action. The operations include initiating, via a differentiated keyboard input system, a drone movement of a fixed, adjustable distance in response to a keyboard tap. The operations include employing, via an absolute position-based interface, absolute position-based commands to control the drone.

According to other aspects of the present disclosure, the operations may include one or more of the following features. The operations may further include enhancing spatial awareness and predictive control accuracy of the drone via the visual position indicator system. The operations may further include providing, via the visual position indicator system, an augmented reality indication of where the drone is going to move in response to a particular user interaction. The operations may further include providing, via the mouse-based control system, precise drone positioning despite latency. The operations may further include enabling, via the differentiated keyboard input system, predictable and precise increments of drone movement. The operations may further include defining, via user-defined settings, the fixed, adjustable distance for the keyboard tap.

According to another aspect of the present disclosure, a computer-implemented method for controlling a drone using a web-based interface is provided. The method includes receiving, via an absolute position-based control system, a user input indicating a fixed, adjustable distance for a drone movement. The method includes initiating, by the absolute position-based control system, the drone movement based on the fixed, adjustable distance. The method includes displaying, via an augmented reality predictive visualization system, the drone's future travel distance and final position using a dual-circle indicator system, wherein a first circle represents the drone's current position and a second circle represents the drone's intended destination. The method includes facilitating, via a precision mouse control system, precise drone positioning using at least one of a double-click action for fixed-distance travel or scroll controls for fine-tuning adjustments.

According to other aspects of the present disclosure, the method may include one or more of the following features. The user input may be a keyboard tap. The fixed, adjustable distance may be defined by user settings. The augmented reality predictive visualization system may display the drone's future travel distance and final position in a three-dimensional augmented reality environment. The dual-circle indicator system may include a smaller circle representing the drone's current position and a larger circle representing the drone's intended destination. The absolute position-based control system may enable predictable and precise increments in drone control and movement. The augmented reality predictive visualization system may enhance spatial awareness, predictive control accuracy, and facilitate precise drone positioning despite latency. The precision mouse control system may enable fine-tuning adjustments for precise drone control. The method may further include receiving, via the precision mouse control system, a double-click action, and initiating, by the absolute position-based control system, a fixed-distance travel for the drone in a direction indicated by the double-click action. The method may further include receiving, via the precision mouse control system, a scroll control input, and adjusting, by the absolute position-based control system, the drone's position based on the scroll control input.

According to another aspect of the present disclosure, a system for controlling a drone using a web-based interface is provided. The system includes an absolute position-based control system configured to receive a user input indicating a fixed, adjustable distance for a drone movement and initiate the drone movement based on the fixed, adjustable distance. The system includes an augmented reality predictive visualization system configured to display the drone's future travel distance and final position using a dual-circle indicator system, wherein a first circle represents the drone's current position and a second circle represents the drone's intended destination. The system includes a precision mouse control system configured to facilitate precise drone positioning using at least one of a double-click action for fixed-distance travel or scroll controls for fine-tuning adjustments.

According to other aspects of the present disclosure, the system may include one or more of the following features. The user input may be a keyboard tap. The fixed, adjustable distance may be defined by user settings. The augmented reality predictive visualization system may be configured to display the drone's future travel distance and final position in a three-dimensional augmented reality environment. The dual-circle indicator system may include a smaller circle representing the drone's current position and a larger circle representing the drone's intended destination. The absolute position-based control system may be configured to enable predictable and precise increments in drone control and movement. The augmented reality predictive visualization system may be configured to enhance spatial awareness, predictive control accuracy, and facilitate precise drone positioning despite latency. The precision mouse control system may be configured to enable fine-tuning adjustments for precise drone control. The precision mouse control system may be further configured to receive a double-click action and cause the absolute position-based control system to initiate a fixed-distance travel for the drone in a direction indicated by the double-click action. The precision mouse control system may be further configured to receive a scroll control input and cause the absolute position-based control system to adjust the drone's position based on the scroll control input.

According to another aspect of the present disclosure, a method for controlling a drone using a web-based interface is provided. The method includes receiving, via the web-based interface, a user input indicating a desired movement of the drone, wherein the user input is a keyboard tap. The method includes determining, based on the keyboard tap, a predefined, customizable distance for the desired movement of the drone. The method includes displaying, in a 3D augmented reality environment of the web-based interface, visual indicators representing the drone's projected path and destination prior to executing the desired movement. The method includes representing, via a dual-circle indicator system in the web-based interface, the drone's current position with a first visual marker and the drone's intended destination with a second visual marker, wherein the first visual marker is smaller than the second visual marker.

According to other aspects of the present disclosure, the method may include one or more of the following features. The web-based interface may further include user settings for defining the predefined, customizable distance for the desired movement of the drone. The web-based interface may further include mouse interactions for enabling fixed-distance travel of the drone in an indicated direction via a double-click action and fine-tuning adjustments of the drone's position via scroll controls. The visual indicators in the 3D augmented reality environment may include the drone's future travel distance and final position. The dual-circle indicator system may facilitate precise drone positioning despite latency.

According to another aspect of the present disclosure, a system for controlling a drone using a web-based interface is provided. The system includes a user input module configured to receive, via the web-based interface, a user input indicating a desired movement of the drone, wherein the user input is a keyboard tap. The system includes a distance determination module configured to determine, based on the keyboard tap, a predefined, customizable distance for the desired movement of the drone. The system includes a display module configured to display, in a 3D augmented reality environment of the web-based interface, visual indicators representing the drone's projected path and destination prior to executing the desired movement. The system includes a dual-circle indicator module configured to represent, via a dual-circle indicator system in the web-based interface, the drone's current position with a first visual marker and the drone's intended destination with a second visual marker, wherein the first visual marker is smaller than the second visual marker.

According to other aspects of the present disclosure, the system may include one or more of the following features. The web-based interface may further include user settings for defining the predefined, customizable distance for the desired movement of the drone. The web-based interface may further include mouse interactions for enabling fixed-distance travel of the drone in an indicated direction via a double-click action and fine-tuning adjustments of the drone's position via scroll controls. The visual indicators in the 3D augmented reality environment may include the drone's future travel distance and final position. The dual-circle indicator system may facilitate precise drone positioning despite latency.

According to another aspect of the present disclosure, a non-transitory computer-readable medium storing instructions that, when executed by a processor, cause the processor to perform a method for controlling a drone using a web-based interface is provided. The method includes receiving, via the web-based interface, a user input indicating a desired movement of the drone, wherein the user input is a keyboard tap. The method includes determining, based on the keyboard tap, a predefined, customizable distance for the desired movement of the drone. The method includes displaying, in a 3D augmented reality environment of the web-based interface, visual indicators representing the drone's projected path and destination prior to executing the desired movement. The method includes representing, via a dual-circle indicator system in the web-based interface, the drone's current position with a first visual marker and the drone's intended destination with a second visual marker, wherein the first visual marker is smaller than the second visual marker.

According to other aspects of the present disclosure, the method may include one or more of the following features. The web-based interface may further include user settings for defining the predefined, customizable distance for the desired movement of the drone. The web-based interface may further include mouse interactions for enabling fixed-distance travel of the drone in an indicated direction via a double-click action and fine-tuning adjustments of the drone's position via scroll controls. The visual indicators in the 3D augmented reality environment may include the drone's future travel distance and final position. The dual-circle indicator system may facilitate precise drone positioning despite latency.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a block diagram of a precision teleoperation system for remote control of an unmanned aerial vehicle (UAV), according to aspects of the present disclosure.

FIG. 2A illustrates an operator interface in a preview state showing current-state and commanded-state markers, according to aspects of the present disclosure.

FIG. 2B illustrates the operator interface of FIG. 2A in an execution state showing lag offset between markers, according to an embodiment.

FIG. 2C illustrates the operator interface of FIG. 2A in a converged state with aligned markers, according to an embodiment.

FIG. 3 illustrates an operational method for handling keyboard and pointing-device inputs in a precision teleoperation mode, according to aspects of the present disclosure.

FIG. 4 illustrates a UAV architecture, according to aspects of the present disclosure.

FIG. 5 illustrates a user-interface state machine for a latency-aware precision control mode, according to aspects of the present disclosure.

FIG. 6 illustrates an overlay-computation dataflow for generating current-state and preview overlays, according to aspects of the present disclosure.

FIG. 7 illustrates an input-decision logic flow for distinguishing between tap and press inputs, according to aspects of the present disclosure.

FIG. 8 illustrates alternative embodiments of interface elements, command primitives, confirmation mechanisms, and queueing policies, according to aspects of the present disclosure.

FIG. 9 illustrates a method for controlling an unmanned aerial vehicle via a web-based interface, according to aspects of the present disclosure.

FIG. 10 illustrates a method for controlling a drone using a web-based interface with dual-circle indicators, according to aspects of the present disclosure.

FIG. 11 illustrates a method for controlling a drone using a web-based interface via an absolute position-based control system, according to aspects of the present disclosure.

FIG. 12 illustrates a method for controlling a drone using a web-based interface with keyboard tap input and user-defined settings, according to aspects of the present disclosure.

FIG. 13 illustrates a flow diagram of a method for controlling an UAV using position-based command generation and predictive visualization, according to aspects of the present disclosure.

FIG. 14 is a block diagram of a computer system as may be used to implement features of the disclosed embodiments.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

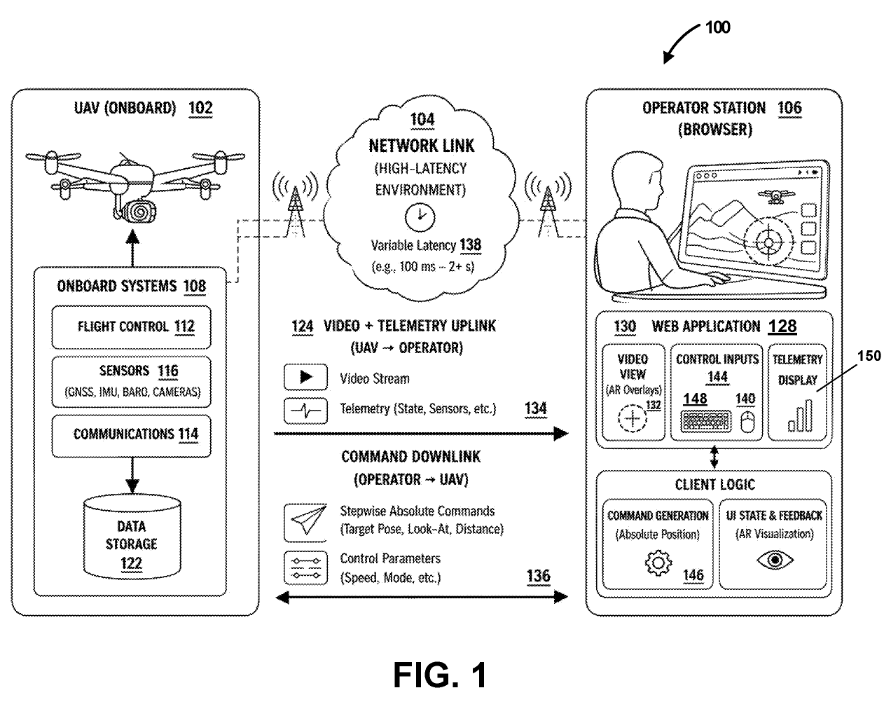

Referring to FIG. 1, a precision teleoperation system 100 may be configured to support remote control of an unmanned aerial vehicle (UAV) 102 using a web-based operator interface in a latency-affected environment. The system 100 may address challenges associated with controlling UAVs when communication links introduce delays between operator inputs and vehicle responses. In some cases, round-trip latency of up to several seconds may occur, particularly in radio-frequency-congested environments or when operating at extended ranges. Under such conditions, video feedback and telemetry received by an operator may represent a past state of the UAV 102 rather than an instantaneous state, which may complicate precise positioning tasks.

Conventional drone control interfaces may rely on velocity-based or rate-based commands, in which the duration or magnitude of an operator input is mapped to a corresponding velocity or rate of movement. While such interfaces may be intuitive in low-latency conditions, velocity-based control may present challenges when communication delays are present. Under latency, the same input duration may produce different movement increments depending on timing and network conditions, which may lead to inconsistent vehicle behavior. Operators may find it difficult to achieve precise positioning when the relationship between input duration and resulting displacement becomes unpredictable.

With continued reference to FIG. 1, the precision teleoperation system 100 may employ stepwise position-based commands rather than velocity-based commands to achieve predictable and precise drone control despite network delays. The system 100 may include an operator station 106 configured to execute a browser application 128. The operator station 106 may include a live video renderer 130 configured to display video frames received from the UAV 102 within a video viewport. The operator station 106 may further include an overlay renderer 132 configured to render augmented reality overlays within the video viewport. The augmented reality overlays may include a current-state marker representing a current position or viewing state of the UAV 102 derived from received telemetry, and a commanded-state marker representing an intended position or viewing state selected by an operator.

In contrast to conventional velocity-based control systems in which motion of the UAV 102 is directly governed by continuously applied user input, the system 100 generates position-based commands that define target positions for the UAV 102. Characteristics of a user input event, including duration, may be used to determine a type, magnitude, or frequency of command generation. However, once a position-based command is generated, execution of the command proceeds toward the defined target position without requiring continuous user input during execution. In this manner, control of the UAV 102 is based on discrete command generation rather than continuous real-time input modulation.

The system 100 may employ a dual-indicator approach in which spatial separation between the current-state marker and the commanded-state marker indicates a lag condition between a reported UAV state and a commanded UAV state. This visual representation may enable an operator to understand whether the UAV 102 is still moving toward a commanded state or whether displayed video lags behind actual motion. When the current-state marker and the commanded-state marker become aligned or substantially coincident, the operator may understand that the UAV 102 has reached the intended state.

The operator station 106 may include an input handling subsystem 144 configured to receive input events from at least one of a keyboard input device 148 or a pointing input device 140. In some cases, the input handling subsystem 144 may discriminate between a tap input and a press input received from the keyboard input device 148. A command generation subsystem 146 may be configured to generate a fixed-distance movement command in response to a tap input, where the fixed distance may be defined by a user-selectable movement increment stored in a user settings store 142. The command generation subsystem 146 may also be configured to generate a fixed-distance travel command in a direction indicated by a double-click action received from the pointing input device 140. In some implementations, a scroll input from the pointing input device 140 may adjust a movement distance associated with an intended endpoint.

The network link 104 may provide an uplink 134 for telemetry and video data 124 and a downlink 136 for control commands. The network link 104 may be subject to a latency condition 138 that may include transport delay, variable delay, jitter, or intermittent loss. The architecture of the system 100 may separate onboard execution at the UAV 102 from offboard command generation and overlay rendering at the operator station 106, while preserving a closed-loop interaction in which the operator station 106 renders delayed current-state information, generates a commanded-state representation, and transmits a command for execution by the UAV 102. This arrangement may support a precision teleoperation mode by allowing the operator station 106 to present both current and intended vehicle states notwithstanding the latency condition 138 of the network link 104.

Because each position-based command defines a target position rather than a rate of motion, variations in communication delay do not alter the intended final position of the UAV 102. While latency may affect a timing at which commands are received or state information is updated, execution of a given command proceeds toward the defined target position irrespective of such variations. As a result, control accuracy and predictability are maintained even in the presence of communication latency or jitter.

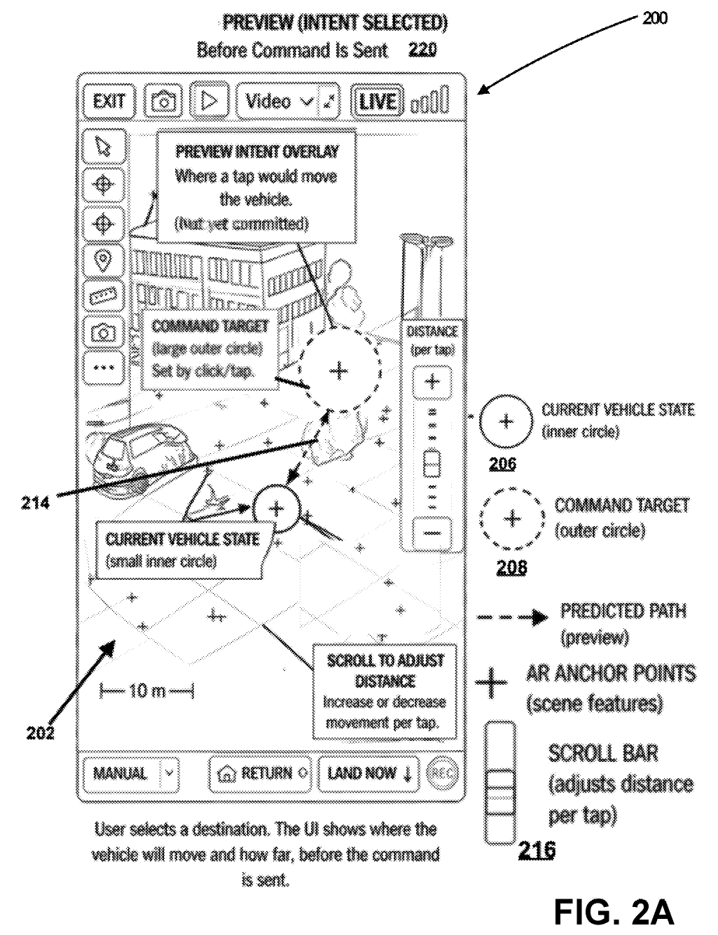

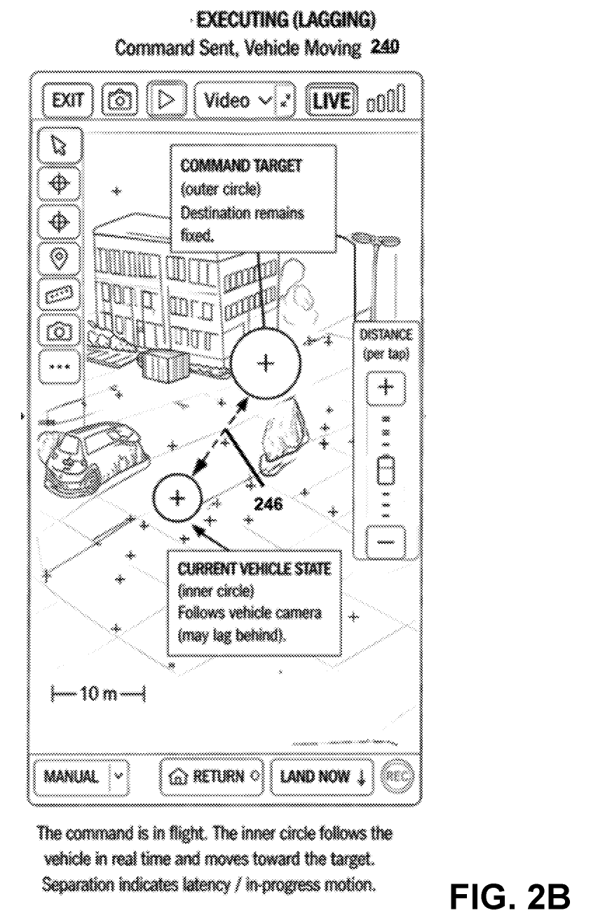

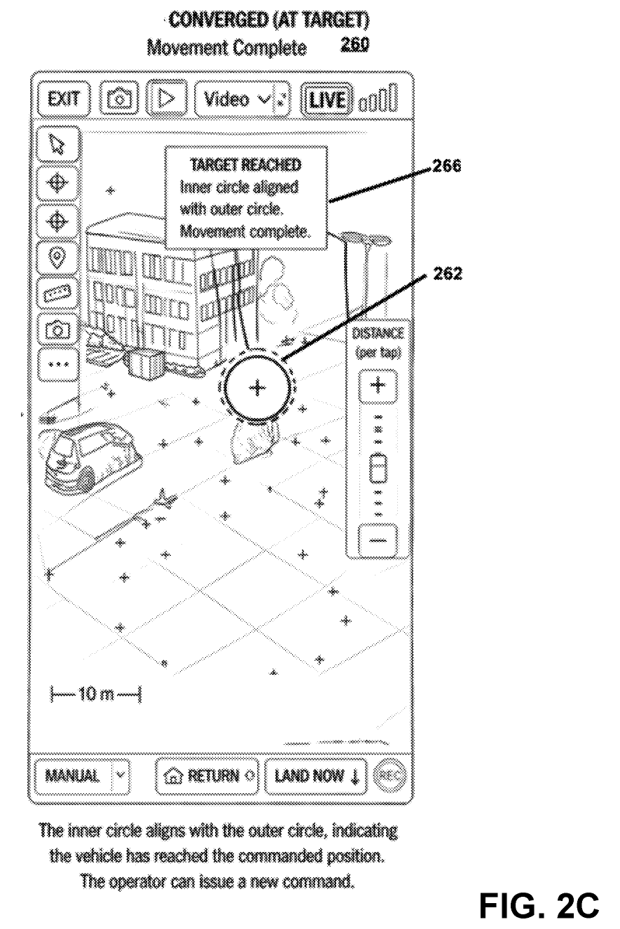

The precision teleoperation system 100 and associated methods described herein may provide a number of technical effects and advantages in the context of remote UAV control. Referring to FIGS. 1 and 2A-2C, the system 100 may enhance spatial awareness and predictive control accuracy by displaying a UAV's future travel distance and final position within a video viewport 202 before the UAV 102 executes a movement. The visual position indicator system, including the dual-indicator overlay comprising the current-state marker 206 and the commanded-state marker 208, may provide an augmented reality indication of where the UAV 102 is going to move in response to a particular user interaction. This predictive visualization may allow an operator to anticipate the UAV's movements before execution and to make necessary adjustments prior to committing a command.

With continued reference to FIGS. 2A-2C, the dual-indicator overlay system may enable precise drone positioning despite latency conditions affecting the network link 104. The current-state marker 206 may represent the UAV's current position as derived from received telemetry, while the commanded-state marker 208 may represent the intended destination selected by the operator. The spatial separation between the current-state marker 206 and the commanded-state marker 208 may visually communicate a lag condition, enabling the operator to understand whether the UAV 102 is still moving toward the commanded state or whether displayed video lags behind actual motion. When the current-state marker 206 and the commanded-state marker 208 become aligned or substantially coincident, as shown in the converged state 260 of FIG. 2C, the operator may understand that the UAV 102 has reached the intended state.

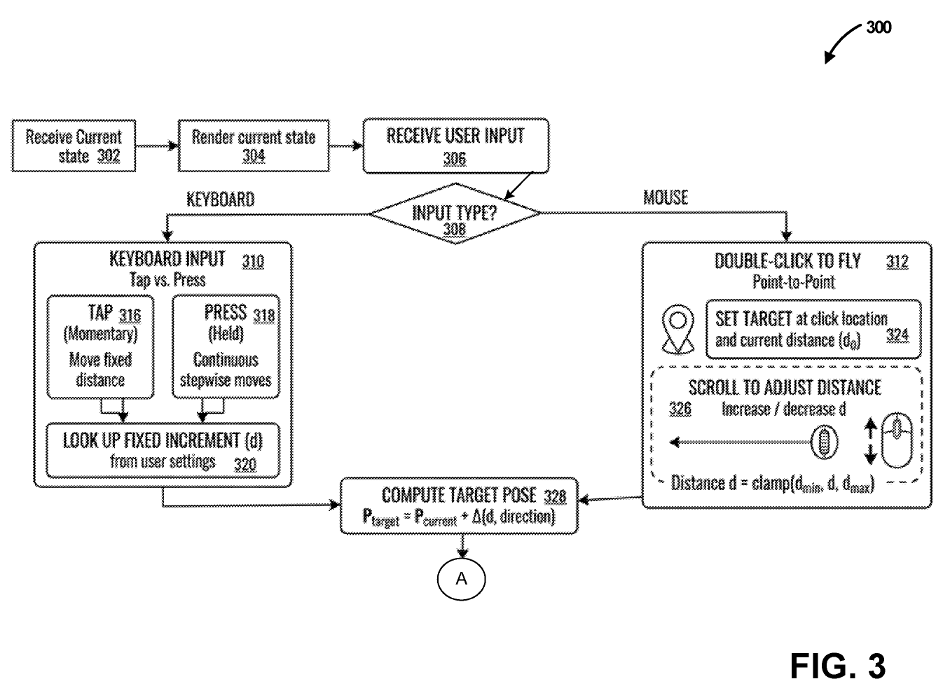

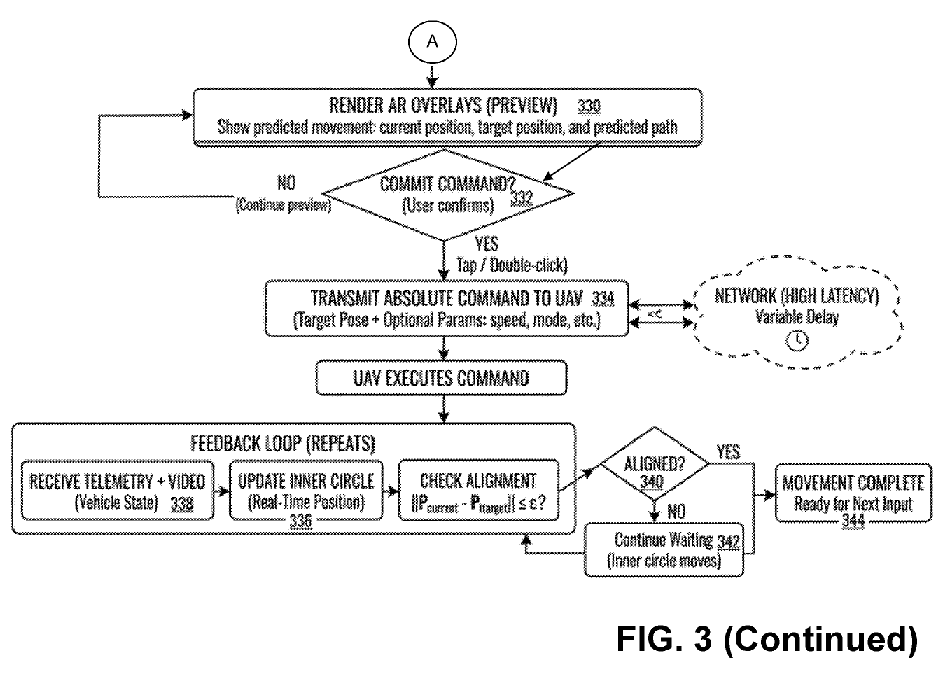

Referring to FIG. 3, the operational method 300 may enable predictable and consistent increments of drone movement through the use of stepwise position commands rather than velocity-based commands. In velocity-based or rate-based control systems, the same input duration may produce different movement increments depending on timing and network conditions, which may lead to inconsistent vehicle behavior under latency. By contrast, the command generation subsystem 146 of the system 100 may generate absolute-position-based commands or fixed-distance movement commands that specify an explicit target position or displacement, such that the resulting movement may be independent of network timing variations. The differentiated keyboard input system, implemented through the input handling subsystem 144, may discriminate between a tap input and a press input, and may generate a fixed-distance movement command in response to a tap input based on a user-selectable movement increment stored in the user settings store 142.

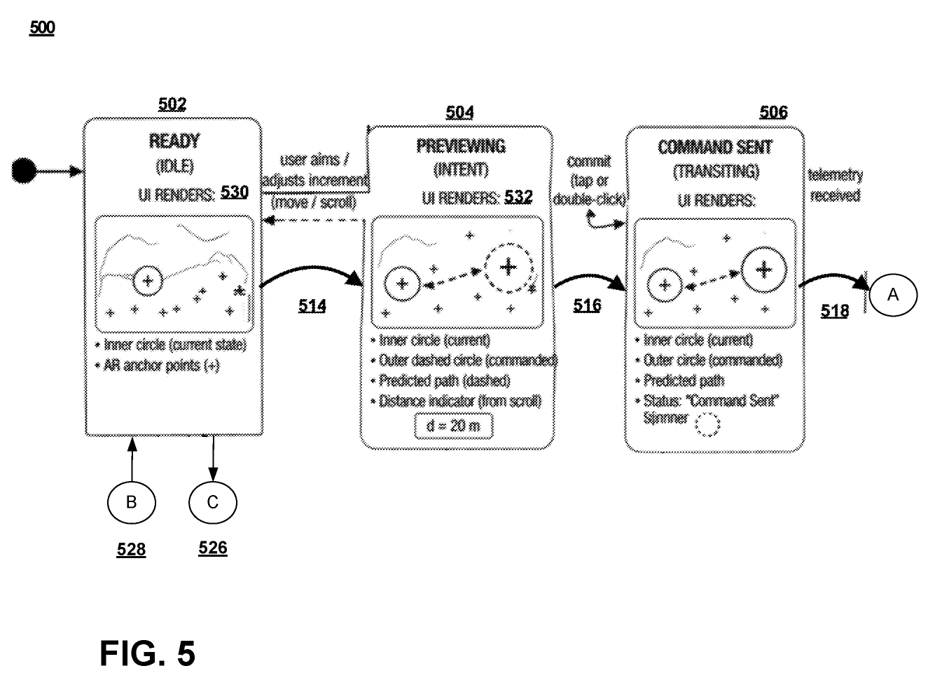

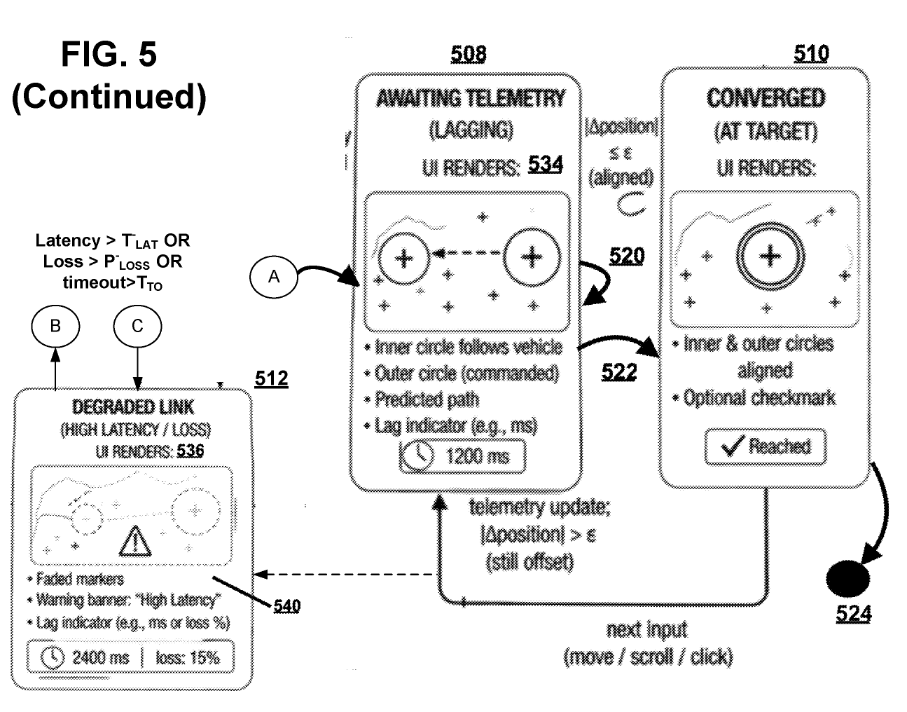

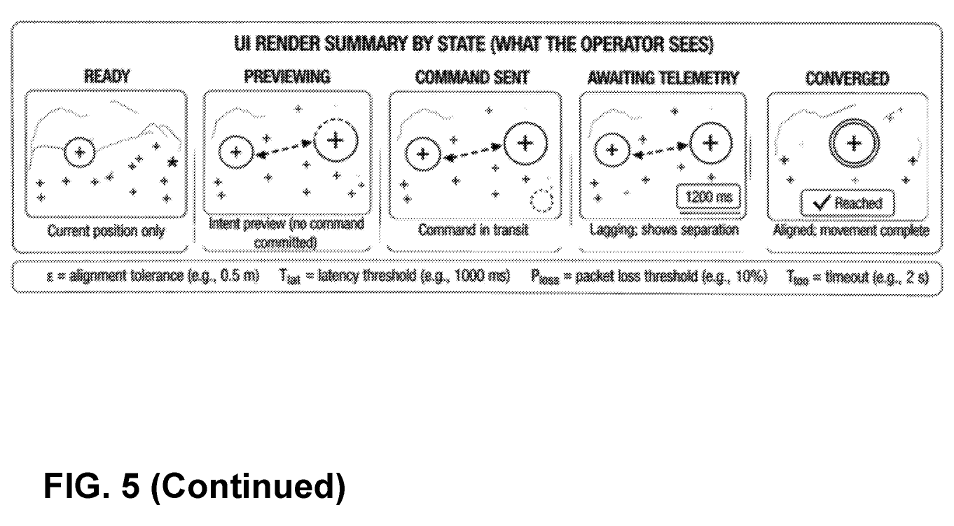

With continued reference to FIGS. 2A-2C and 5, the dual-indicator overlay system may support a move-and-wait workflow in which discrete inputs cause predictable steps and the interface visually communicates whether the vehicle has caught up to the commanded movement. As shown in the state machine 500 of FIG. 5, the operator interface may transition through a ready state 502, a previewing state 504, a command-sent state 506, an awaiting-telemetry state 508, and a converged state 510. In the awaiting-telemetry state 508, the interface may continue to display separation between the current-state marker and the commanded-state marker while the UAV 102 moves toward the commanded position. When a convergence condition is satisfied, as evaluated at the convergence evaluation 340 of FIG. 3, the interface may transition to the converged state 510 and display an aligned marker condition 262, signaling that the interface has returned to a condition suitable for the next precision input. This move-and-wait workflow may allow operators to issue a discrete command, observe the UAV's progress toward the commanded state through the dual-indicator visualization, and wait for convergence before issuing a subsequent command.

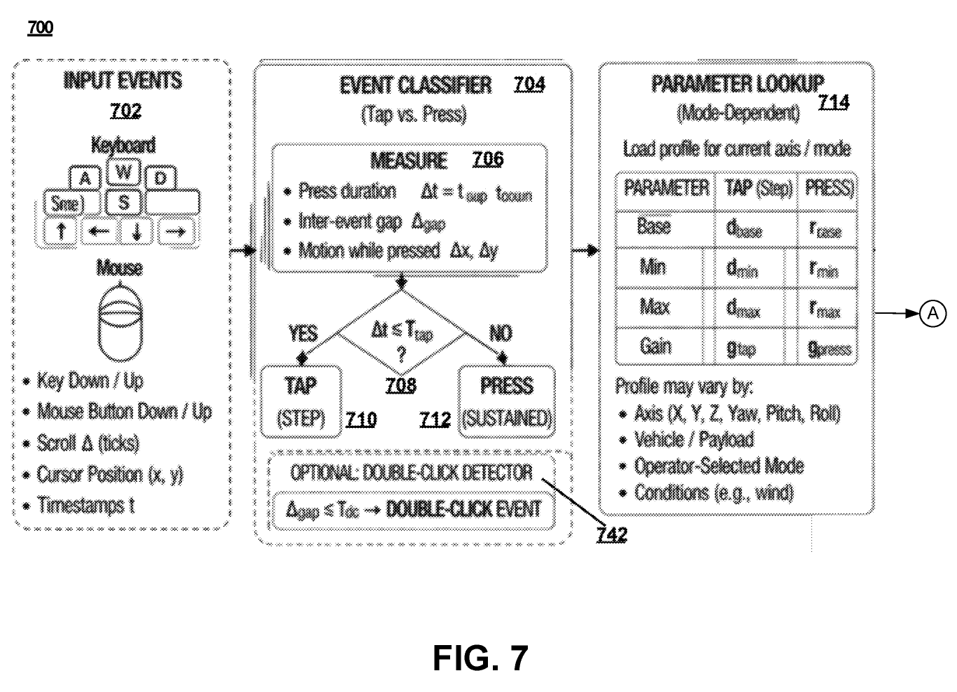

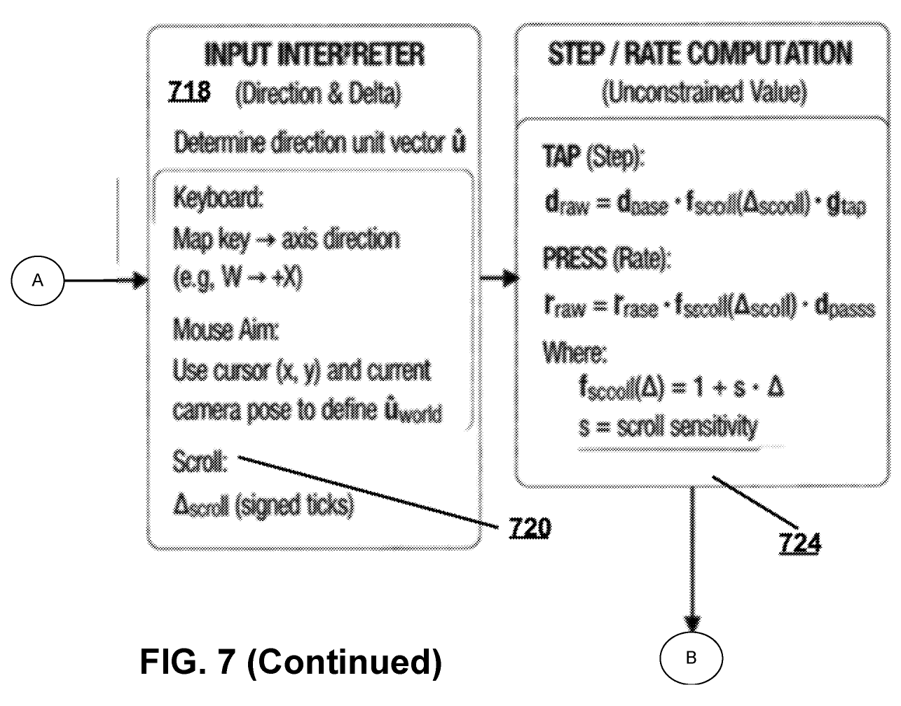

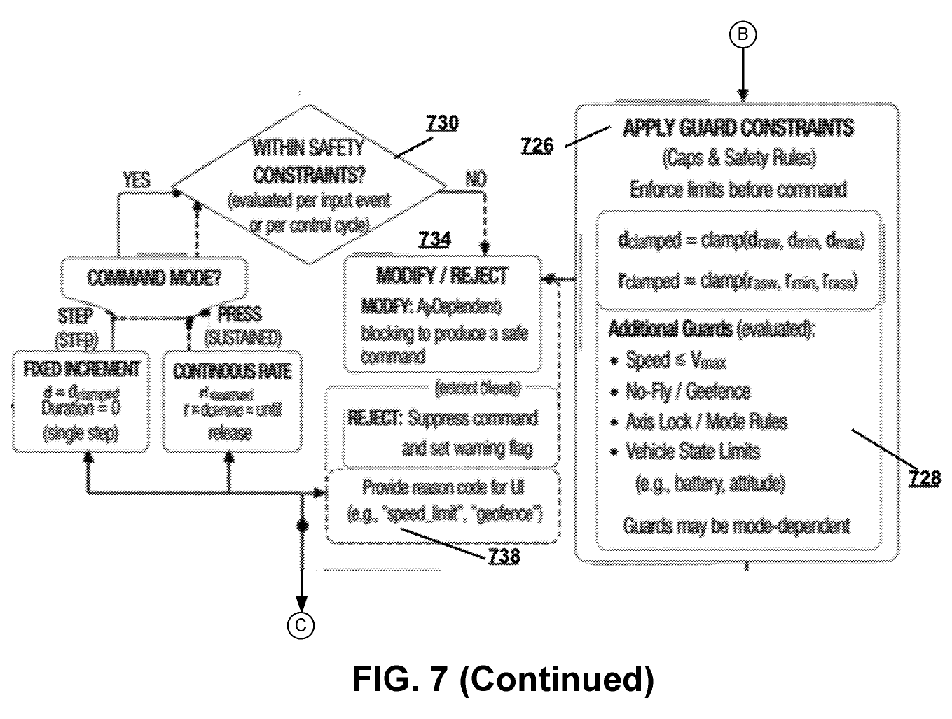

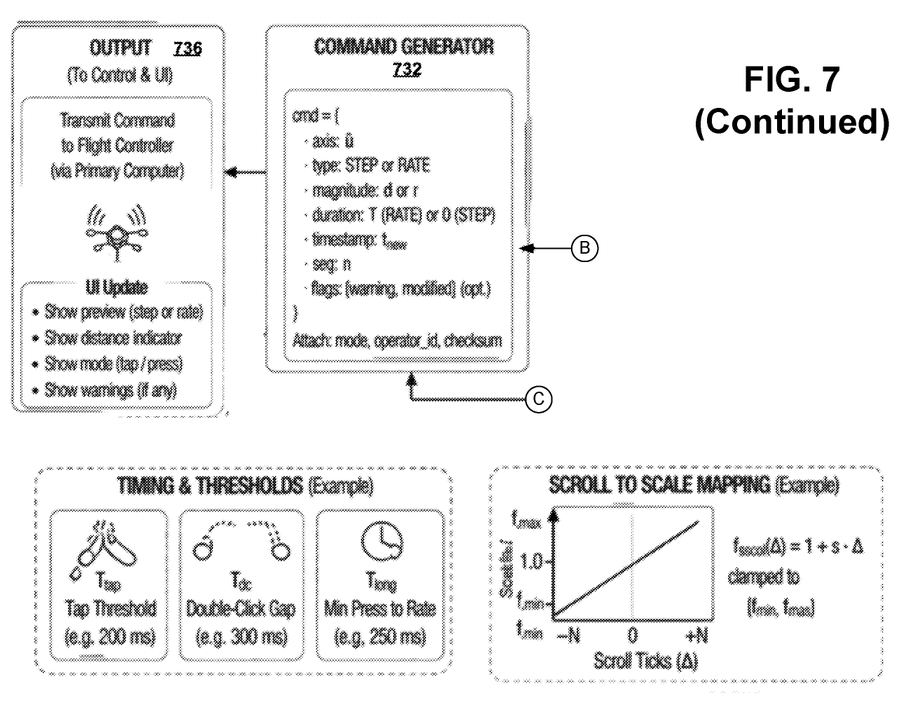

Referring to FIG. 7, the input-decision logic 700 may provide fine-tuning adjustments for precise drone control through the combination of keyboard and pointing-device inputs. The mouse-based control system, implemented through the input handling subsystem 144 and the pointing input device 140, may receive a double-click action to initiate fixed-distance travel in a direction indicated by the double-click action, and may receive a scroll input 720 to adjust a movement distance associated with an intended endpoint. These features may collectively contribute to precise positioning of the UAV 102 despite the presence of latency on the network link 104.

The system 100 may address challenges associated with high-latency environments, where traditional velocity-based controls may result in unpredictable and inconsistent drone movements. By employing absolute position-based commands, the system 100 may provide a more stable and predictable control mechanism. The use of stepwise position commands may decouple the resulting displacement from the timing characteristics of the network link 104, such that an operator input of a given type may produce a consistent movement increment regardless of variable delay, jitter, or intermittent loss conditions. This approach may be beneficial in scenarios requiring precise navigation and asset inspection, where accuracy and reliability may affect mission outcomes. The integration of predictive visualization through the overlay renderer 132, combined with the stepwise command semantics implemented by the command generation subsystem 146, may provide operators with a comprehensive understanding of the UAV's intended path and may support consistent and controlled operation even in challenging latency conditions.

Referring to FIG. 1, a precision teleoperation system 100 may be configured to support remote control of an unmanned aerial vehicle (UAV) 102 using a web-based operator interface in a latency-affected environment. The system 100 may include the UAV 102, a network link 104, and an operator station 106 communicatively coupling the UAV 102 and the operator station 106. The system 100 may address challenges associated with controlling UAVs when communication links introduce delays between operator inputs and vehicle responses.

The UAV 102 may include an onboard compute system 108, a secondary onboard compute system 110, a flight control subsystem 112, a communication subsystem 114, a sensor subsystem 116, an imaging subsystem 118, an actuation subsystem 120, and onboard data storage 122. The sensor subsystem 116 may include one or more position, attitude, motion, or environmental sensors that provide vehicle-state data to the onboard compute system 108. In some cases, the sensor subsystem 116 may include positioning sensors, inertial measurement units, pressure sensors, or other sensors configured to generate telemetry information representing a current state of the UAV 102. The imaging subsystem 118 may include one or more onboard cameras configured to generate a live video stream for transmission to the operator station 106. State information of the UAV may include one or more parameters indicative of a current physical state of the UAV, including position, orientation, velocity, or sensor-derived estimates thereof.

With continued reference to FIG. 1, the flight control subsystem 112 may be configured to receive command information from the onboard compute system 108 and to drive the actuation subsystem 120 to move the UAV 102 in accordance with a commanded motion. The actuation subsystem 120 may include motors, propulsion elements, or control surfaces that effect movement of the UAV 102. The communication subsystem 114 may be configured to transmit telemetry and video data 124 from the UAV 102 and to receive command information for execution. The onboard compute system 108 may include a primary processor 126 for performing flight-critical functions. The secondary onboard compute system 110 may perform non-flight-critical functions while the onboard compute system 108 performs flight-critical functions. The onboard data storage 122 may store telemetry, contingency information, or other flight-related information.

The operator station 106 may include a browser application 128, a live video renderer 130, an overlay renderer 132, a pointing input device 140, a user settings store 142, an input handling subsystem 144, a command generation subsystem 146, and a keyboard input device 148. The browser application 128 may execute on a client device and may receive telemetry and video data 124 from the UAV 102 through the network link 104. The live video renderer 130 may present received video frames to an operator within a video viewport. The overlay renderer 132 may superimpose visual indicators corresponding to current vehicle state, commanded vehicle state, or previewed movement within the video viewport.

As further shown in FIG. 1, the input handling subsystem 144 may receive input events from the keyboard input device 148 and the pointing input device 140. In some implementations, the input handling subsystem 144 may discriminate between a tap input and a press input received from the keyboard input device 148. The command generation subsystem 146 may convert input events into command data appropriate for transmission to the UAV 102. The command generation subsystem 146 may be configured to generate stepwise position commands or absolute-position-based commands rather than velocity-only commands. By generating position-based commands rather than velocity-based commands, the command generation subsystem 146 may provide improved predictability under network delay, as the resulting displacement may be independent of network timing variations. The user settings store 142 may store a user-selectable movement increment used for keyboard tap inputs or click-to-fly operations.

The network link 104 may provide an uplink 134 for telemetry and video data 124 and a downlink 136 for control commands. The network link 104 may be subject to a latency condition 138 that may include transport delay, variable delay, jitter, or intermittent loss. Under the latency condition 138, telemetry and video received at the operator station 106 may represent a past state of the UAV 102 rather than an instantaneous state. In some operating conditions, round-trip delays of up to several seconds may occur, particularly in radio-frequency-congested environments or when operating at extended ranges.

With continued reference to FIG. 1, the arrangement of the system 100 may separate onboard execution at the UAV 102 from offboard command generation and overlay rendering at the operator station 106. The system 100 may preserve a closed-loop interaction in which the operator station 106 renders delayed current-state information, generates a commanded-state representation, and transmits a command for execution by the UAV 102. The overlay renderer 132 may render a current-state marker representing a current position or viewing state of the UAV 102 derived from received telemetry, and a commanded-state marker representing an intended position or viewing state selected by an operator. Spatial separation between the current-state marker and the commanded-state marker may indicate a lag condition between a reported UAV state and a commanded UAV state. This architecture may support a precision teleoperation mode by allowing the operator station 106 to present both current and intended vehicle states notwithstanding the latency condition 138 of the network link 104.

Referring to FIGS. 2A-2C, an operator interface 200 may be rendered at the operator station 106 and configured to present a live video scene together with augmented reality overlays corresponding to current and intended UAV motion. The operator interface 200 may include a video viewport 202 within which a live video image is displayed. A current-state marker 206 may be rendered within the video viewport 202 to represent a current estimated position or viewing state of the UAV 102 derived from received telemetry. A commanded-state marker 208 may be rendered within the video viewport 202 to represent an intended or commanded position selected by the operator.

The rendered scene within the video viewport may include live video imagery, reconstructed environment representations, simulated environments, or augmented reality overlays. A location selected within the scene may be mapped to a corresponding spatial position for the UAV.

In some implementations, the current-state marker 206 may be smaller than the commanded-state marker 208, such that the operator can distinguish actual state from intended state at a glance. The operator interface 200 may also represent a preview of an expected destination, viewing direction, displacement amount, or movement path before an associated command is committed for execution. A commanded-state marker 208 may be rendered at or near a pointing-device selected location. A preview path indicator 214 may extend between the current-state marker 206 and the commanded-state marker 208 to indicate the direction and magnitude of a proposed movement.

With continued reference to FIGS. 2A-2C, a distance adjustment control 216 may be presented in association with the operator interface 200 to indicate or modify a selected travel amount. A commit action may correspond to a keyboard tap, double click, or equivalent input event that causes a previewed action to be transmitted as a command. The operator interface 200 may be configured to communicate lag semantics through relative spatial separation of the current-state marker 206 and the commanded-state marker 208.

The current-state marker 206 and the commanded-state marker 208 may correspond to distinct semantic representations. The current-state marker 206 may represent a telemetry-derived estimate of the UAV state, while the commanded-state marker 208 may represent a target state defined by a generated command. Spatial separation between the markers may therefore represent a state error or difference between the UAV’s current state and the commanded target position during execution.

When the current-state marker 206 is displaced from the commanded-state marker 208, the operator may understand that the UAV 102 is still moving toward the commanded state or that displayed video lags behind actual motion. When the current-state marker 206 and the commanded-state marker 208 become aligned or substantially coincident, the operator may understand that the UAV 102 has reached the intended state or that displayed state has converged to the commanded state. The operator interface 200 may therefore support not only preview of intended motion but also display of in-progress and converged conditions, enabling the operator to adopt a move-and-wait precision workflow in which a discrete input causes a predictable step and the operator interface 200 visually communicates whether the UAV 102 has caught up to the commanded movement.

FIG. 2A illustrates a preview state 220 of the operator interface 200 in which a current-state marker 206 remains at a presently reported vehicle state, while a commanded-state marker 208 and a preview path indicator 214 are rendered to show where the UAV 102 will move or point if the operator commits the input. A distance adjustment control 216 may indicate the selected increment associated with the previewed action. In the preview state 220, the commanded-state marker 208 may be displayed before transmission of an associated control command, thereby allowing the operator to inspect or revise the proposed movement before execution. The operator may still change the intended location or target location of the UAV 102 by revising the location of the commanded-state marker 208 while in the preview state 220.

FIG. 2B illustrates an execution state 240 in which a current-state marker 206 trails a commanded-state marker 208, with a lag offset 246 (e.g., the preview path indicator 214) between the markers visually indicating latency or incomplete execution. The preview path indicator 214 indicator may act as in-progress path indicator to reinforce that the UAV 102 is moving toward the commanded position. The spatial separation between the current-state marker 206 and the commanded-state marker 208 may provide the operator with a visual indication of the lag condition, enabling the operator to understand the relationship between the reported UAV state and the commanded UAV state during command execution.

FIG. 2C illustrates a converged state 260 in which an aligned marker condition 262 is shown in the operator interface, thereby indicating that the current reported UAV state has converged to the commanded state. A ready indication 266 may be presented to signal that the operator interface 200 has returned to a condition suitable for the next precision input. In the converged state 260, the current-state marker and the commanded-state marker may be substantially coincident or aligned within a convergence threshold, indicating that the UAV 102 has reached the intended position.

In some embodiments, convergence may be determined when a difference between the current state and the target position falls within a predefined threshold. The threshold may be defined in positional, angular, or image-space terms. When the convergence condition is satisfied, the system may render an indication of alignment between the markers, indicating completion or near-completion of the commanded movement.

Together, FIGS. 2A-2C depict preview, execution, and convergence states of a dual-indicator interface logic. The dual-indicator approach may communicate lag semantics through relative spatial separation of the current-state marker and the commanded-state marker. In the preview state 220, the operator may inspect a proposed movement before committing the associated command. In the execution state 240, the operator may observe the lag offset 246 between the markers while the UAV 102 moves toward the commanded position. In the converged state 260, the aligned marker condition 262 may indicate that the UAV 102 has reached the intended state and that the operator interface 200 is ready for a subsequent precision input. This progression of states may support a precision teleoperation workflow in which the operator issues a discrete command, observes the UAV's progress toward the commanded state through the dual-indicator visualization, and waits for convergence before issuing a subsequent command.

Referring to FIG. 3, an operational method 300 may be performed for handling keyboard and pointing-device inputs in a precision teleoperation mode. The operational method 300 may enable an operator station 106 to receive, classify, and process user input events, generate corresponding commands, and manage the display of current-state and commanded-state indicators throughout a command execution cycle.

At a receive-state step 302, the operator station 106 may receive live video and telemetry from the UAV 102 and may maintain a displayed current-state representation. The receive-state step 302 may establish a baseline representation of the UAV's position or viewing state derived from received telemetry data. At a render-current-state step 304, the operator station 106 may render a current-state marker within the operator interface 200. The current-state marker may represent the current estimated position or viewing state of the UAV 102 as derived from the received telemetry.

With continued reference to FIG. 3, at a receive-input step 306, the operator station 106 may receive a user input event from at least one of the keyboard input device 148 or the pointing input device 140. At an input-classification step 308, the operator station 106 may classify the input event by source or input type. The input-classification step 308 may route the input event into a keyboard branch 310 or a pointer branch 312 based on the source of the input event.

User input events may include discrete input events and sustained input events. Discrete input events may include taps, clicks, or short-duration activations, while sustained input events may include prolonged key presses or continuous pointer interactions. Different classes of input events may be mapped to different command generation behaviors.

If the input event is classified into the keyboard branch 310, the operational method 300 may proceed to evaluate a duration of the input event. The operator station 106 may evaluate an input duration or input characteristic to determine whether the input event corresponds to a tap determination 316 or a press determination 318. The duration-evaluation process may compare the input duration to a tap threshold to discriminate between tap and press inputs.

If the input event is determined to be a tap at the tap determination 316, the operational method 300 may proceed to a fixed-increment computation 320. At the fixed-increment computation 320, the operator station 106 may compute a fixed movement increment based on a stored user setting or other selected increment value stored in the user settings store 142. The fixed-increment computation 320 may retrieve a user-selectable movement increment and may apply the user-selectable movement increment to determine a displacement magnitude for the commanded movement.

If the input event is determined to be a press at the press determination 318, the operational method 300 may proceed to an alternate press handling 322. At the alternate press handling 322, an alternate control treatment may be selected. In some implementations, the alternate control treatment may include repeated issuance of increments, sustained control handling, or another non-tap behavior.

As further shown in FIG. 3, if the input event is classified into the pointer branch 312, the operational method 300 may proceed to a target-selection step 324. At the target-selection step 324, the operator station 106 may determine a pointer-selected target location or pointing direction based on the position of the pointing input device 140. The operational method 300 may also proceed to a scroll-adjustment step 326 to receive a scroll-based adjustment indicating a modified movement distance. The scroll-adjustment step 326 may allow an operator to modify or scale a movement parameter associated with the intended endpoint.

At an intended-state computation 328, whether reached from the keyboard branch 310 or the pointer branch 312, the operator station 106 may compute an intended endpoint, intended pose, or other intended movement state corresponding to the input event. The intended-state computation 328 may generate a representation of the target position or viewing state that the UAV 102 will assume upon execution of the associated command.

In some embodiments, the intended endpoint may be determined by applying a displacement to a current position of the UAV. The displacement may be defined by a direction and a magnitude, where the direction is derived from user input and the magnitude may be predefined, user-configurable, or dynamically adjusted.

With continued reference to FIG. 3, at a preview-render step 330, the operator station 106 may render a preview overlay showing the intended result of the prospective movement. The preview overlay may include a commanded-state marker 208 and a preview path indicator 214 extending between the current-state marker 206 and the commanded-state marker 208. The preview-render step 330 may allow the operator to inspect or revise the proposed movement before execution.

In some embodiments, determination of the intended endpoint and rendering of a corresponding preview representation are decoupled from execution of the associated command. Execution may be initiated only in response to a discrete commit action, allowing a user to evaluate and adjust the intended movement prior to initiating UAV motion.

At a commit determination 332, the operator station 106 may determine whether a commit condition has been satisfied. The commit condition may correspond to receipt of a keyboard tap, a double-click event from the pointing input device 140, or another commit action. If the commit condition is not satisfied, the operational method 300 may return to an earlier step to allow the operator to continue adjusting the intended endpoint. If the commit condition is satisfied, the operational method 300 may proceed to a command-transmission step 334.

At the command-transmission step 334, the operator station 106 may transmit a stepwise position command, an absolute target command, or another command corresponding to the intended endpoint to the UAV 102. The command-transmission step 334 may cause the command generation subsystem 146 to generate and transmit the command over the network link 104 for execution by the UAV 102.

In some embodiments, the UAV 102 executes a received position-based command using a position control loop configured to reduce a difference between a current state of the UAV 102 and the target position (e.g., intended endpoint) defined by the command. The control loop may adjust propulsion, orientation, or other actuation parameters to converge toward the target position. Execution of the command may proceed autonomously once initiated, without requiring continued user input, until the UAV 102 reaches the target position or a convergence condition is satisfied.

At a dual-marker render step 336, the operator station 106 may render both current-state and commanded-state indicators within the video viewport 202. The dual-marker render step 336 may allow the operator to see the relationship between the displayed actual state and the intended state. Spatial separation between the current-state marker and the commanded-state marker may indicate a lag condition between the reported UAV state and the commanded UAV state.

As further shown in FIG. 3, at a telemetry-receipt step 338, the operator station 106 may receive updated telemetry from the UAV 102. The updated telemetry may indicate an updated current position or viewing state of the UAV 102 as the UAV 102 moves toward the commanded position. At a convergence evaluation 340, the operator station 106 may evaluate whether an alignment or convergence condition has been met between the current-state representation and the commanded-state representation. The convergence evaluation 340 may compare the current-state marker position to the commanded-state marker position to determine whether the UAV 102 has reached the intended endpoint.

If convergence has not yet been reached, the operational method 300 may loop through a wait-and-update loop 342. The wait-and-update loop 342 may continue to display a lag condition while awaiting additional telemetry, thereby allowing the operator to observe the UAV's progress toward the commanded state through the dual-indicator visualization. When convergence is satisfied, the operational method 300 may proceed to a completion step 344. At the completion step 344, the operator interface 200 may return to a completion or ready condition, signaling that the interface is prepared for the next precision input.

The operational method 300 may thereby support differentiated input recognition, preview-before-commit behavior, command transmission, and convergence-based completion. By discriminating between tap and press inputs and by handling both keyboard and pointing device inputs within a unified method flow, the operational method 300 may enable predictable and precise increments of UAV movement in latency-affected environments.

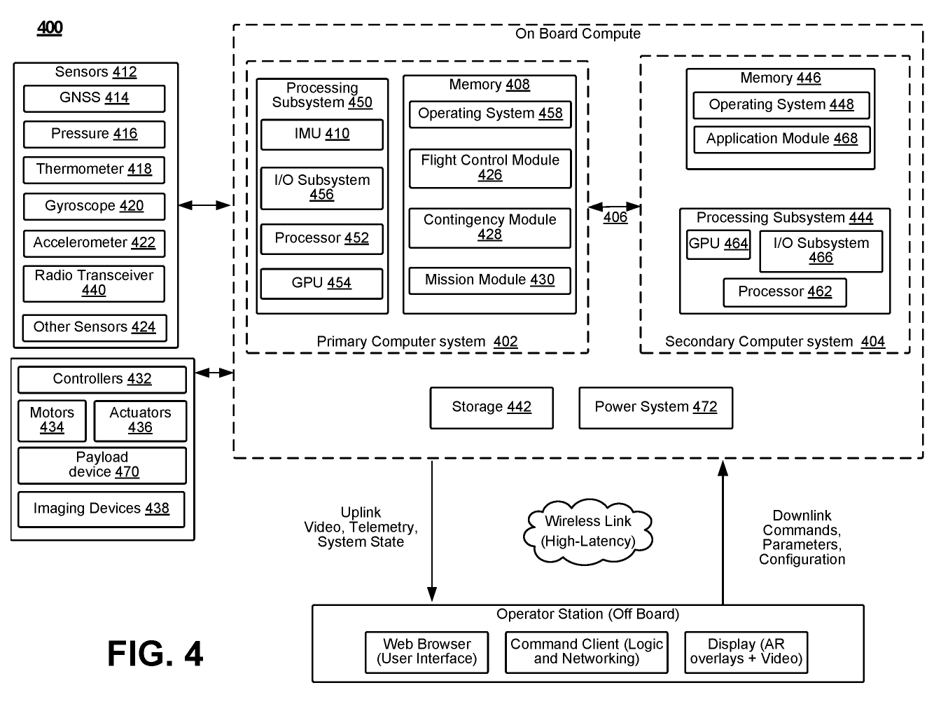

FIG. 4 illustrates an UAV architecture 400 consistent with various embodiments. The UAV architecture 400 may include a primary computer system 402 and a secondary computer system 404 coupled by a bus 406. The primary computer system 402 may include a processing subsystem 450 including one or more processors 452, graphics processing unit 454, I/O subsystem 456, and an inertial measurement unit 410. In addition, the primary computer system 402 can include logic circuits, analog circuits, associated volatile and/or non-volatile memory, associated input/output data ports, power ports, etc., and include one or more software processes executing on one or more processors or computers. The primary computer system 402 can include memory 408.

Memory 408 may include non-volatile memory, such as one or more magnetic disk storage devices, solid-state hard drives, or flash memory. Other volatile memory such as RAM, DRAM, SRAM may be used for temporary storage of data while the UAV is operational. Databases may store information describing UAV flight operations, flight plans, contingency events, geofence information, component information and other information.

The primary computer system 402 may be coupled to one or more sensors 412 for determining vehicle state information. A GNSS receiver 414 may provide positioning data such as latitude, longitude, and altitude information. A pressure sensor 416 may provide altitude or airspeed information. A thermometer 418 may provide environmental temperature data. A gyroscope 420 may provide angular rate information, and an accelerometer 422 may provide linear acceleration data. Other sensors 424 may include magnetometers, current sensors, voltage sensors, or additional sensors configured to provide vehicle-state data to the primary computer system 402. The inertial measurement unit 410 may incorporate one or more of the gyroscope 420 and the accelerometer 422 to support inertial navigation of the UAV 102.

With continued reference to FIG. 4, the primary computer system 402 may execute a flight control module 426, a contingency module 428, and a mission module 430. The flight control module 426 may handle flight control operations of the UAV 102, including autopilot functions and attitude control. The contingency module 428 may monitor and handle contingency events, such as detecting that the UAV 102 has crossed a geofence boundary, detecting a low battery condition, or detecting a malfunction of an onboard sensor or motor. In response to detecting a contingency event, the contingency module 428 may instruct the flight control module 426 to perform a contingency action, such as returning to a predetermined landing location. The mission module 430 may process flight plan information, waypoints, and other mission-related data, and may work in conjunction with the flight control module 426 to autopilot the UAV 102 along a specified flight path. Operating system 458 may include instructions for handling basic system services and for performing hardware dependent tasks.

Controllers 432 may drive motors 434 and actuators 436 to control propulsion and aircraft motion. The motors 434 may be used for rotation of propellers, and the actuators 436 may be used for flight surface control such as ailerons, rudders, flaps, landing gear, or parachute deployment. Controllers 432 may be used to interact with and operate a payload device 470, and other devices such as imaging devices 438. Payload devices 470 or imaging devices 438 may include visible-light cameras, infrared cameras, multispectral cameras, or other data-collection devices. A radio transceiver 440 may provide communication with offboard systems, including the operator station 106. Nonvolatile storage 442 may store telemetry, contingency information, flight plans, geofence information, or other flight-related information.

As further shown in FIG. 4, the secondary computer system 404 may include a secondary processing subsystem 444, secondary memory 446, a secondary operating environment 448, and secondary application modules 468. The secondary processing subsystem 444 includes one or more processors 462, GPU 464, and I/O subsystem 466. The secondary computer system 404 can include logic circuits, analog circuits, associated volatile and/or non-volatile memory, associated input/output data ports, power ports, etc., and include one or more software processes executing on one or more processors or computers. The secondary memory 446 may include non-volatile memory, such as one or more magnetic disk storage devices, solid-state hard drives, flash memory. Other volatile memory such a RAM, DRAM, SRAM may be used for storage of data while the UAV is operational.

In some implementations, flight-critical operations may be performed by the primary computer system 402, while non-flight-critical or supplemental operations may be performed by the secondary computer system 404. The secondary operating environment 448 may be based on a real-time operating system, UNIX, LINUX, or another operating system. The secondary application modules 468 may include inspection modules, database modules, or other application-specific modules that perform functions that are non-critical in nature, such that if a function fails, the UAV 102 may still operate safely.

The UAV 102 may include an onboard power system 472, such as a battery, that provider power supply to various components, such as motors, imaging devices, payload devices, etc. to perform their operations.

Referring to FIG. 5, a user-interface state machine 500 may govern operation of a latency-aware precision control mode. The state machine 500 may define a plurality of states and transitions that manage the operator interface 200 throughout a command execution cycle, from initial input through convergence of the UAV 102 to a commanded position.

A ready state 502 may correspond to a condition in which the operator interface 200 is available to receive a new precision input. In the ready state 502, the operator interface 200 may display live video and a current-state marker without a preview overlay. A previewing state 504 may correspond to a condition in which an intended movement is being represented visually, but an associated command has not yet been committed. In the previewing state 504, the operator interface 200 may display a commanded-state marker and a preview overlay representing a prospective movement.

With continued reference to FIG. 5, a command-sent state 506 may correspond to a condition immediately following issuance of a command to the UAV 102. An awaiting-telemetry state 508 may correspond to a condition in which the operator interface 200 is waiting for updated telemetry and continuing to display separation between the current-state marker and the commanded-state marker. A converged state 510 may correspond to a condition in which the current-state representation and the commanded-state representation are aligned or satisfy a convergence criterion. A degraded-link state 512 may correspond to a condition in which telemetry freshness, latency, packet loss, timeout, or related transport conditions fail to satisfy a validity requirement.

The state machine 500 may define a plurality of transitions between states. A ready-to-preview transition 514 may cause the state machine 500 to transition from the ready state 502 to the previewing state 504 in response to user aiming, pointer movement, or increment adjustment. A preview-to-command transition 516 may cause the state machine 500 to transition from the previewing state 504 to the command-sent state 506 in response to a commit action such as a keyboard tap or double click from the pointing input device 140.

As further shown in FIG. 5, a command-to-awaiting transition 518 may cause the state machine 500 to transition from the command-sent state 506 to the awaiting-telemetry state 508. An awaiting self-loop 520 may maintain the state machine 500 in the awaiting-telemetry state 508 while updated telemetry continues to show that the current state remains offset from the commanded state. A convergence transition 522 may cause the state machine 500 to transition from the awaiting-telemetry state 508 to the converged state 510 when a convergence threshold is satisfied. A return-to-ready transition 524 may cause the state machine 500 to transition from the converged state 510 to the ready state 502 when the operator interface 200 is prepared for the next precision input.

With continued reference to FIG. 5, a degraded-entry transition 526 may cause the state machine 500 to transition from the ready state 502 to the degraded-link state 512 when a degraded condition 540 is detected. A recovery transition 528 may cause the state machine 500 to transition from the degraded-link state 512 to the ready state 502 when link quality or telemetry validity recovers. The degraded condition 540 may correspond to latency exceeding a threshold, packet loss exceeding a threshold, or a timeout event.

The state machine 500 may define state-associated rendering behaviors for each state. A ready-state rendering 530 may cause the operator interface 200 to show live video and a current-state marker without a preview overlay when the state machine 500 is in the ready state 502. A preview-state rendering 532 may cause the operator interface 200 to show a commanded-state marker and a preview overlay representing a prospective movement when the state machine 500 is in the previewing state 504.

As further shown in FIG. 5, an awaiting-state rendering 534 may cause the operator interface 200 to show both the current-state marker and the commanded-state marker separated by a lag offset when the state machine 500 is in the command-sent state 506 or the awaiting-telemetry state 508. The spatial separation between the current-state marker and the commanded-state marker may visually indicate latency or incomplete execution of the commanded movement. A degraded-state rendering 536 may cause the operator interface 200 to show a warning indicator, a freshness indicator, suppression of a preview overlay, or another user-interface modification associated with stale or unreliable telemetry when the state machine 500 is in the degraded-link state 512.

The convergence threshold may correspond to a positional, directional, or visual alignment criterion that determines when the current-state representation has converged to the commanded-state representation. When the convergence threshold is satisfied, the state machine 500 may transition from the awaiting-telemetry state 508 to the converged state 510 via the convergence transition 522. The convergence threshold may be defined functionally rather than numerically, such that the state machine 500 may support multiple implementations without being limited to a particular parameter value.

The state machine 500 may thereby govern the progression of the operator interface 200 through preview, execution, and convergence states, enabling the operator to adopt a move-and-wait precision workflow in which a discrete input causes a predictable step and the operator interface 200 visually communicates whether the UAV 102 has caught up to the commanded movement.

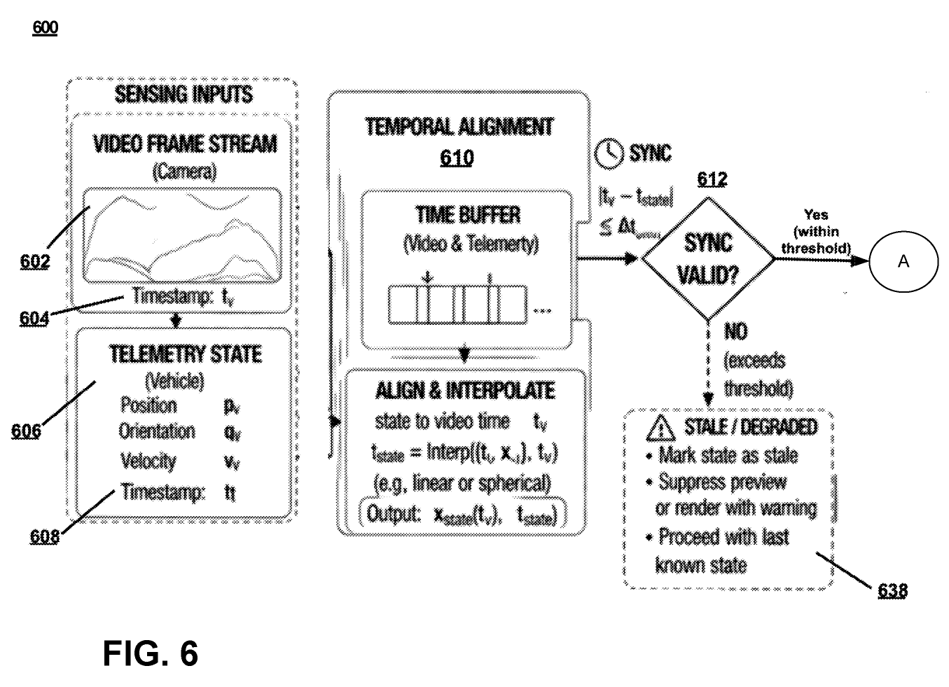

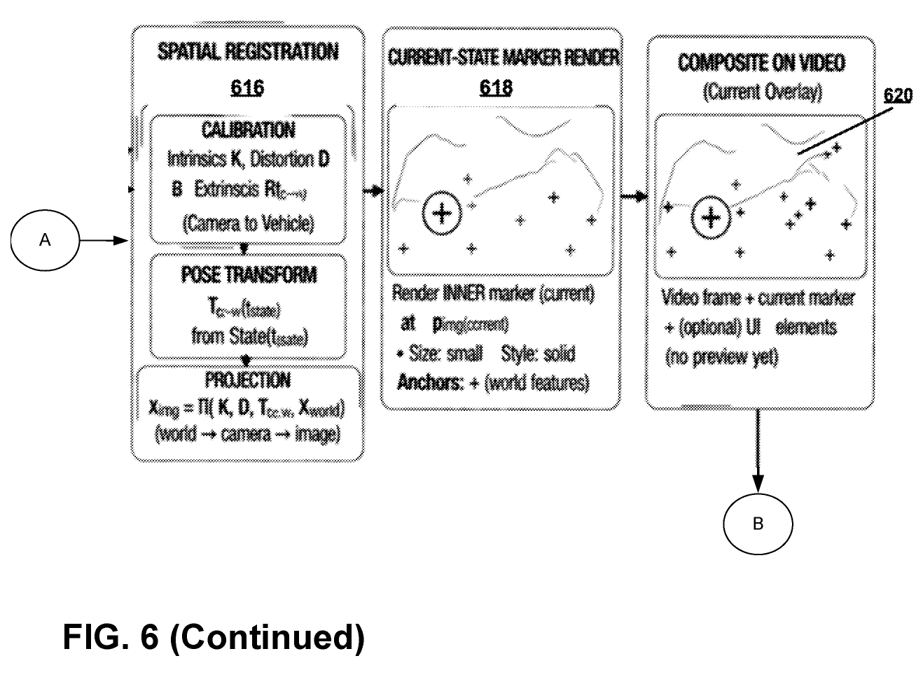

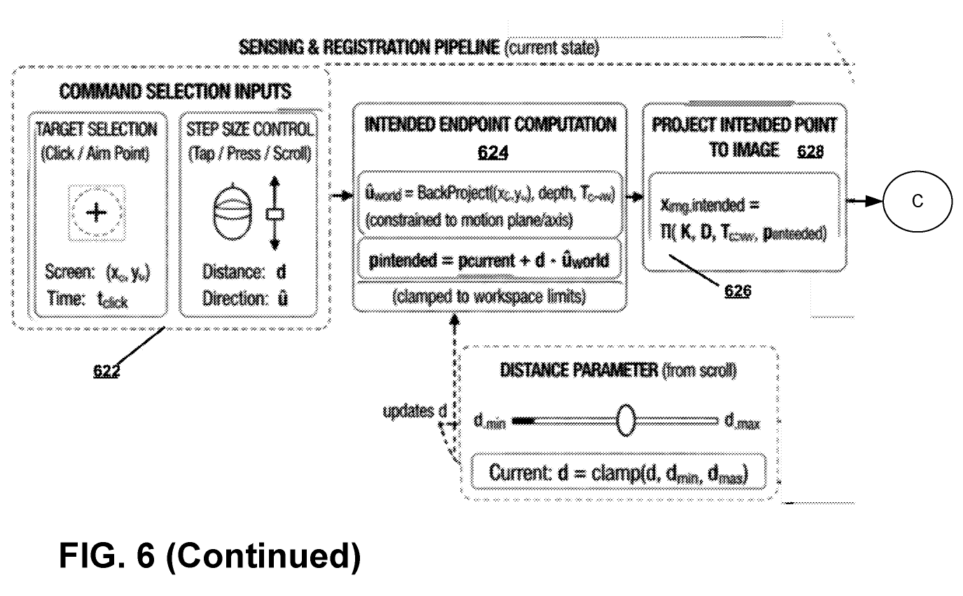

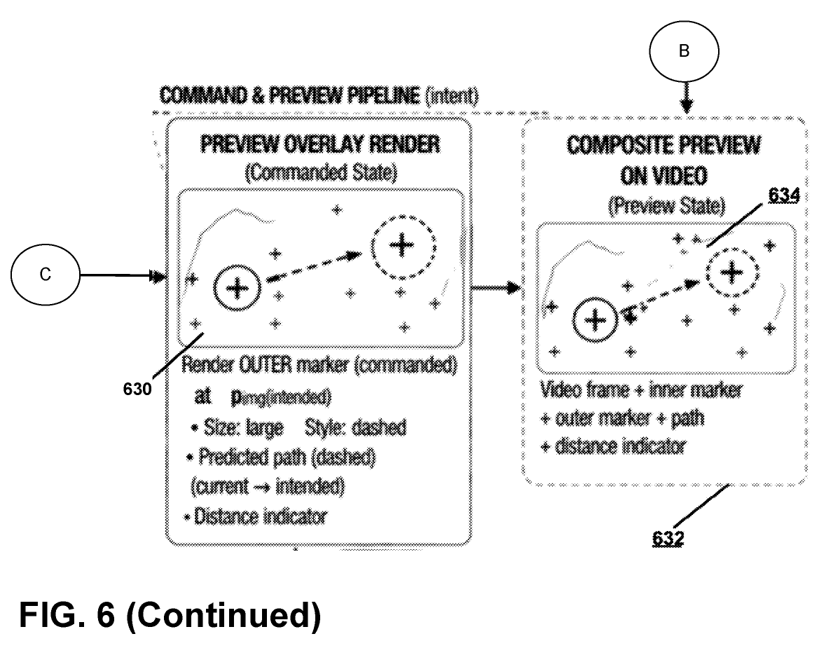

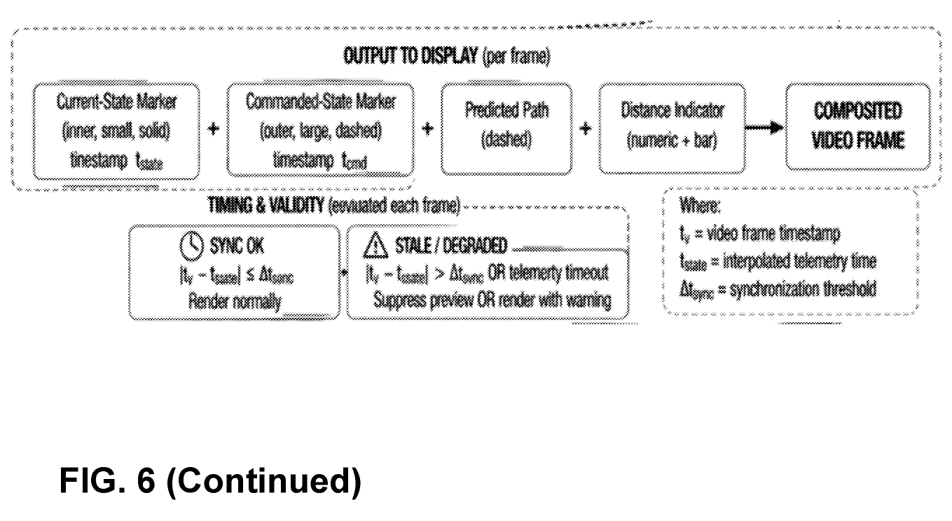

Referring to FIG. 6, an overlay-computation dataflow 600 may be configured to generate current-state and preview overlays from video, telemetry, and operator input. The overlay-computation dataflow 600 may represent a timing-aware process that validates synchronization between video and telemetry inputs, performs spatial registration, generates current-state and intended-state display elements, and conditionally renders warnings or degraded-state outputs when valid synchronization is not present.

A video frame 602 and an associated video timestamp 604 may be provided as inputs to the overlay-computation dataflow 600. The video frame 602 may correspond to a frame of live video received from the UAV 102 through the network link 104. The video timestamp 604 may indicate a capture time or transmission time associated with the video frame 602. A telemetry update 606 and an associated telemetry timestamp 608 may also be provided as inputs to the overlay-computation dataflow 600. The telemetry update 606 may include position, attitude, or other vehicle-state information received from the UAV 102. The telemetry timestamp 608 may indicate a measurement time or transmission time associated with the telemetry update 606.

With continued reference to FIG. 6, a temporal alignment module 610 may receive the video frame 602, the video timestamp 604, the telemetry update 606, and the telemetry timestamp 608. The temporal alignment module 610 may evaluate the temporal correspondence between the video frame 602 and the telemetry update 606. A sync-valid decision 612 may determine whether the telemetry update 606 is sufficiently synchronized with the video frame 602 for accurate overlay registration. The sync-valid decision 612 may evaluate whether the difference between the video timestamp 604 and the telemetry timestamp 608 falls within an acceptable range, or whether other synchronization criteria are satisfied.

If the sync-valid decision 612 determines that the synchronization condition is satisfied, the aligned information may be provided as a synchronized state to a spatial registration module 616. The spatial registration module 616 may map telemetry-derived state information into display coordinates associated with the video frame 602. The spatial registration module 616 may transform position, attitude, or viewing-direction information from a world coordinate frame or vehicle coordinate frame into pixel coordinates or normalized display coordinates suitable for overlay rendering within the video viewport 202.

As further shown in FIG. 6, a current-state projection module 618 may receive the output of the spatial registration module 616 and may generate projected display coordinates for a current-state representation. The current-state projection module 618 may compute the display location at which a current-state marker 206 should be rendered based on the synchronized telemetry-derived state. A current-state render output 620 may produce a corresponding marker or visual element for compositing into the displayed interface. The current-state render output 620 may include geometry, color, size, or other rendering attributes for the current-state marker 206.

In parallel with the current-state processing path, a user input event 622 may be processed by an intent computation module 624. The user input event 622 may correspond to a keyboard tap, a double-click action, a scroll input, or another input event received from the keyboard input device 148 or the pointing input device 140. The intent computation module 624 may generate an intended-endpoint representation 626 corresponding to a previewed or committed movement. The intended-endpoint representation 626 may specify a target position, a displacement vector, a viewing direction, or another representation of the intended movement state.

With continued reference to FIG. 6, the intended-endpoint representation 626 may be provided to an intended-state projection module 628. The intended-state projection module 628 may generate display coordinates for an intended-state marker or preview path based on the intended-endpoint representation 626. The intended-state projection module 628 may transform the intended endpoint from a world coordinate frame or vehicle coordinate frame into display coordinates suitable for overlay rendering. A preview-overlay render output 630 may then be generated. The preview-overlay render output 630 may include geometry, color, size, or other rendering attributes for a commanded-state marker 208, a preview path indicator 214, or other preview overlay elements.

A composition module 632 may combine the current-state render output 620, the preview-overlay render output 630, and the underlying video frame 602 to produce a composited display frame 634. The composition module 632 may layer the overlay elements over the video frame 602 in a manner that preserves visibility of both the live video content and the overlay indicators. The composited display frame 634 may be provided to the live video renderer 130 for presentation within the video viewport 202 of the operator interface 200.

As further shown in FIG. 6, if the sync-valid decision 612 determines that the telemetry update 606 is stale or insufficiently synchronized with the video frame 602, the overlay-computation dataflow 600 may follow a degraded routing path 636. Along the degraded routing path 636, the overlay-computation dataflow 600 may suppress, modify, or qualify one or more overlays. In some cases, the overlay-computation dataflow 600 may produce a stale-data indicator 638 to inform the operator that the telemetry information may not accurately correspond to the displayed video frame 602. The stale-data indicator 638 may include a warning icon, a freshness indicator, a color change applied to one or more overlay elements, or another visual indication of the degraded condition.

The degraded routing path 636 may be invoked when the telemetry timestamp 608 differs from the video timestamp 604 by more than a threshold amount, when the telemetry update 606 has not been received within a timeout period, or when other synchronization validity criteria are not satisfied. By following the degraded routing path 636 and producing the stale-data indicator 638, the overlay-computation dataflow 600 may inform the operator that overlay registration may be unreliable, thereby supporting operator awareness of telemetry freshness conditions.

The overlay-computation dataflow 600 may thereby support generation of spatially registered overlay elements that correspond to both current UAV state and intended UAV state, while providing conditional handling for degraded synchronization conditions. The timing-aware nature of the overlay-computation dataflow 600 may distinguish the disclosed overlay generation from generic overlay drawing operations by validating synchronization, performing coordinate registration, and conditionally rendering degraded-state outputs when valid synchronization is not present.

Referring to FIG. 7, an input-decision logic 700 may be configured to distinguish between tap and press inputs and to apply scroll-based adjustment to movement magnitude or related parameters. The input-decision logic 700 may provide a unified decision framework for processing both keyboard-based and pointer-based input events, evaluating safety constraints, and generating commands for transmission to the UAV 102.

A user input event 702 may be provided to an event classifier 704. The user input event 702 may correspond to a keyboard input, a pointing-device input, or another input event received from the keyboard input device 148 or the pointing input device 140. The event classifier 704 may evaluate characteristics of the user input event 702 to determine how the user input event 702 should be processed.

With continued reference to FIG. 7, the event classifier 704 may evaluate a duration measure 706 associated with the user input event 702. The duration measure 706 may represent the time duration for which a key or button was held before release. A tap-threshold comparator 708 may compare the duration measure 706 to a tap threshold to discriminate between tap and press inputs. If the duration measure 706 is less than or equal to the tap threshold, the user input event 702 may be classified as a tap event. If the duration measure 706 exceeds the tap threshold, the user input event 702 may be classified as a press event.

If the user input event 702 is classified as a tap event, the input-decision logic 700 may proceed along a tap branch 710. The tap branch 710 may route the user input event 702 to processing logic configured to generate a fixed-distance movement command based on a stored user setting. If the user input event 702 is classified as a press event, the input-decision logic 700 may proceed along a press branch 712. The press branch 712 may route the user input event 702 to an alternate control treatment, which may include repeated increment issuance, sustained control handling, or another implementation-specific behavior.

As further shown in FIG. 7, a parameter lookup 714 may retrieve one or more stored settings associated with the user input event 702. The parameter lookup 714 may access the user settings store 142 to retrieve a step magnitude parameter. The step magnitude parameter may correspond to a user-selectable movement increment that defines the displacement magnitude for a tap-initiated movement command.

A direction or target determination 718 may identify the intended axis, direction, pointer-selected location, or other movement target associated with the user input event 702. For keyboard inputs, the direction or target determination 718 may identify a directional axis based on which key was pressed. For pointing-device inputs, the direction or target determination 718 may identify a target location based on a pointer position or click location within the video viewport 202.

With continued reference to FIG. 7, a scroll input 720, when present, may modify or scale a movement parameter to produce an adjusted magnitude 722. The scroll input 720 may correspond to a scroll wheel rotation or equivalent scroll gesture received from the pointing input device 140. The adjusted magnitude 722 may represent a modified movement distance that differs from the default step magnitude parameter based on the scroll input 720. The scroll input 720 may thereby allow an operator to fine-tune a movement distance before committing a command. In some embodiments, the intended endpoint or target position may be updated based on incremental adjustment inputs, enabling fine refinement of a previously determined target position.

In some embodiments, keyboard input events may be classified as discrete input events or sustained input events based on a duration of the input. For example, a short-duration key press may be treated as a discrete input event and may result in determination of a target position corresponding to a predefined displacement along a direction associated with the key. In contrast, a prolonged key press may be treated as a sustained input event and may result in successive target positions being determined along the corresponding direction, such that repeated position-based commands may be generated.

In some implementations, scroll input may be used to adjust a magnitude of displacement associated with a target position. For example, a scroll input may increase or decrease a distance of movement along a selected axis or depth direction, thereby modifying a subsequently determined target position or refining a previously determined target position.

A command primitive selector 724 may determine whether the user input event 702 will be implemented using an incremental position command, an absolute target command, or another supported primitive. The command primitive selector 724 may select a command type based on the nature of the user input event 702, the current state of the operator interface 200, or other factors. In some implementations, the command primitive selector 724 may select an incremental delta-pose command for keyboard tap inputs and an absolute-target command for click-to-fly inputs.

As further shown in FIG. 7, the resulting candidate command may be subjected to a safety-constraint evaluation 726. The safety-constraint evaluation 726 may consider an operating-limits set 728 that defines constraints applicable to the candidate command. The operating-limits set 728 may include geofence limits, movement bounds, altitude limits, safety caps, or similar constraints that define permissible operating parameters for the UAV 102.

A within-safety decision 730 may determine whether the candidate command satisfies the constraints defined in the operating-limits set 728. The within-safety decision 730 may evaluate whether the intended endpoint or displacement would cause the UAV 102 to exceed a geofence boundary, violate an altitude limit, or otherwise exceed a defined operating constraint.

With continued reference to FIG. 7, if the within-safety decision 730 determines that the candidate command satisfies the applicable constraints, a command generator 732 may produce an outbound control command for transmission. The command generator 732 may format the command according to a protocol suitable for transmission over the network link 104. A command output 736 may provide the outbound control command to the command generation subsystem 146 for transmission to the UAV 102.

If the within-safety decision 730 determines that the candidate command does not satisfy the applicable constraints, the input-decision logic 700 may follow a modify-or-reject path 734. Along the modify-or-reject path 734, the candidate command may be clipped, revised, deferred, or rejected. In some implementations, the modify-or-reject path 734 may cause the candidate command to be modified to comply with the operating-limits set 728, such as by reducing a movement distance to remain within a geofence boundary. In other implementations, the modify-or-reject path 734 may cause the candidate command to be rejected without modification.

A user-interface feedback output 738 may be generated to inform the operator of a modified or rejected condition. The user-interface feedback output 738 may cause the overlay renderer 132 to display a warning indicator, a constraint boundary visualization, or another visual indication that the candidate command was modified or rejected due to a safety constraint. The user-interface feedback output 738 may thereby support operator awareness of operating constraints and the reasons for command modification or rejection.

As further shown in FIG. 7, the input-decision logic 700 may include a pointer-event path for processing pointing-device inputs. The pointer-event path may route pointing-device inputs to processing logic configured to handle click-to-fly operations and scroll-based adjustments. A double-click detector 742 may detect a double-click action from the pointing input device 140. The double-click detector 742 may evaluate the timing between successive click events to determine whether the click events constitute a double-click action.

A fixed-distance click-to-fly branch may process double-click actions detected by the double-click detector 742. The fixed-distance click-to-fly branch may generate a fixed-distance travel command in a direction indicated by the double-click action. The direction may be determined based on the pointer position at the time of the double-click action relative to a reference point within the video viewport 202.

The input-decision logic 700 may thereby provide a unified decision framework in which both keyboard-based and pointer-based command semantics can be evaluated. By discriminating between tap and press inputs, applying scroll-based adjustments, evaluating safety constraints, and generating commands through a common processing flow, the input-decision logic 700 may support predictable and precise increments of UAV movement while enforcing operating constraints defined in the operating-limits set 728.

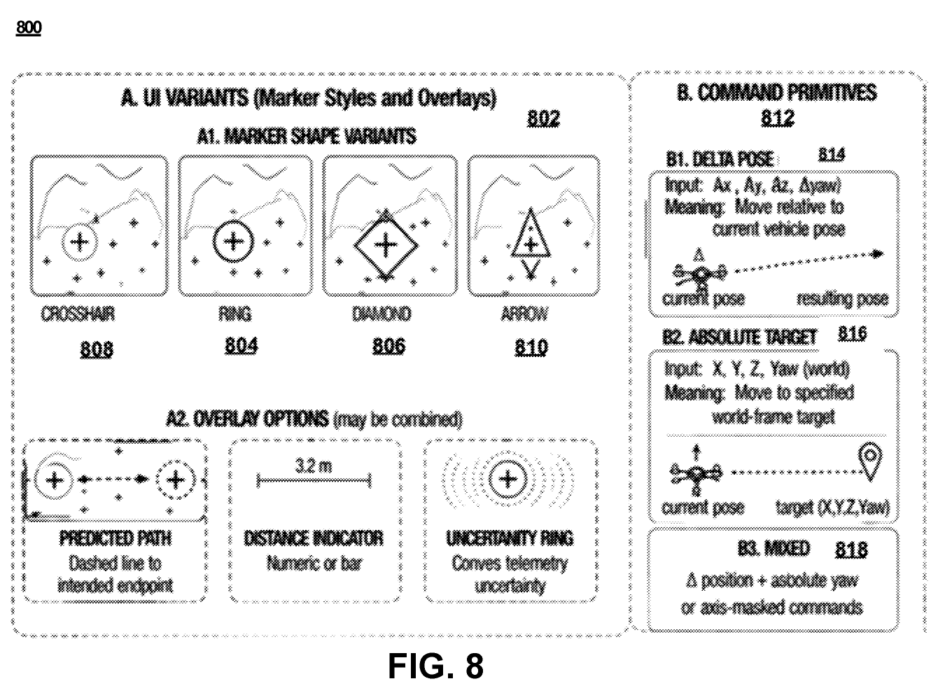

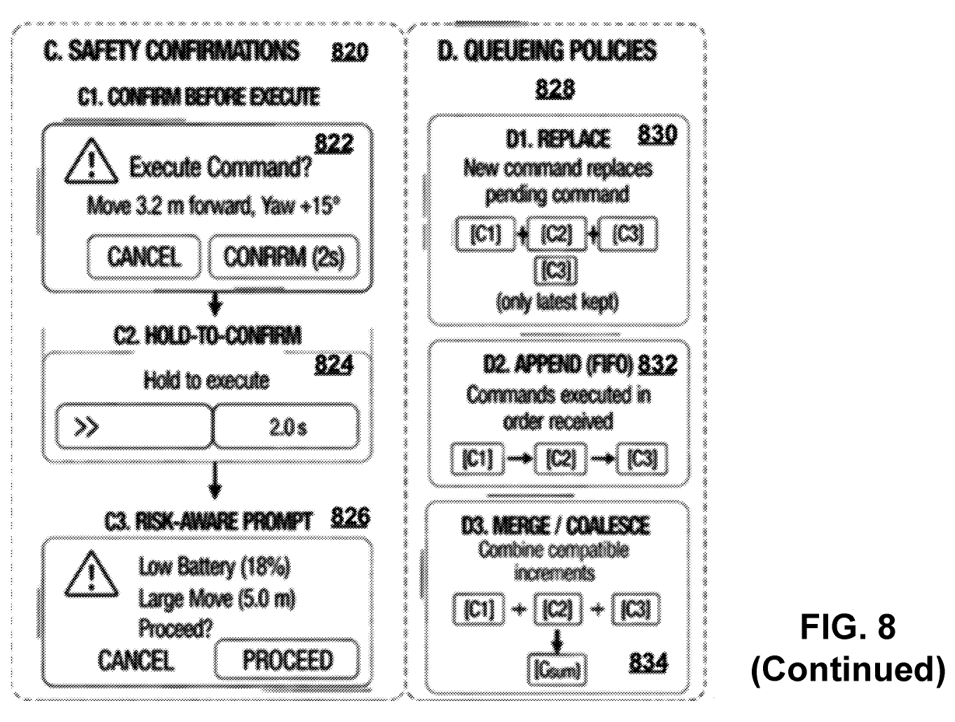

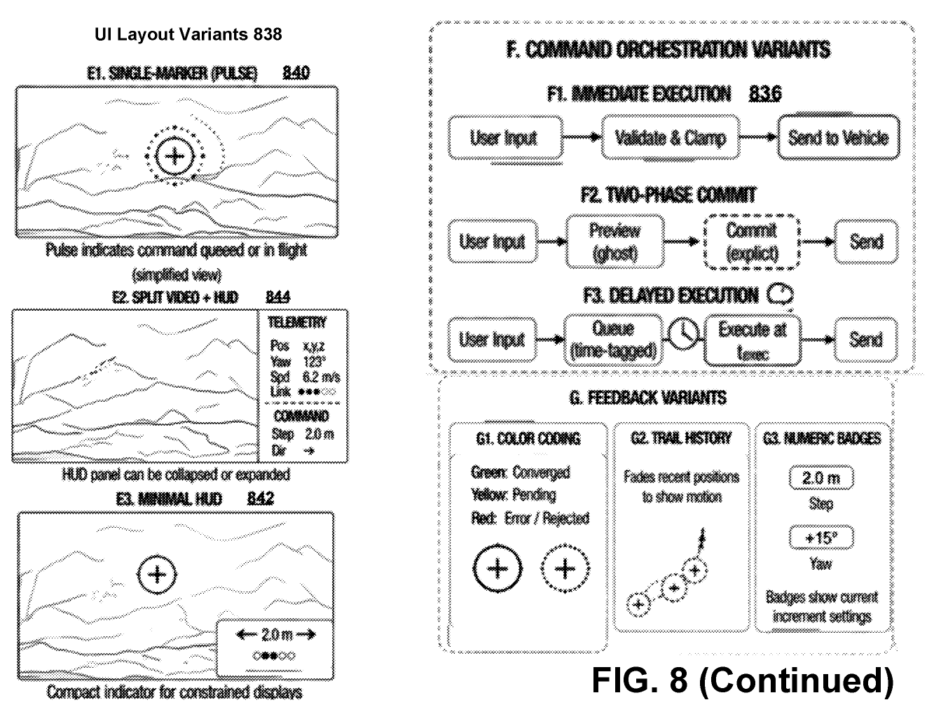

Referring to FIG. 8, an alternative embodiments sheet 800 may illustrate non-limiting variations of interface elements, command primitives, confirmation mechanisms, and queueing policies that may be employed in the precision teleoperation system 100. The alternative embodiments sheet 800 may demonstrate that the disclosed interaction model may support multiple implementations without being limited to a single user-interface configuration.

A marker-family region 802 may illustrate a plurality of marker shapes that may be used as a current-state marker, a commanded-state marker, or both. The marker-family region 802 may include a ring marker 804, a diamond marker 806, a crosshair marker 808, and an arrow or reticle marker 810. In some implementations, the ring marker 804 may be rendered as a circular outline surrounding a reference point within the video viewport 202. The diamond marker 806 may be rendered as a four-sided polygon oriented with vertices at cardinal positions. The crosshair marker 808 may be rendered as intersecting horizontal and vertical lines centered on a reference point. The arrow or reticle marker 810 may be rendered as a directional indicator or targeting reticle. Any of the marker shapes shown in the marker-family region 802 may be used interchangeably as the current-state marker 206 or the commanded-state marker 208 described with reference to FIGS. 2A-2C.

With continued reference to FIG. 8, a command-primitives region 812 may illustrate a plurality of command types that may be generated by the command generation subsystem 146. The command-primitives region 812 may include an incremental delta-pose command 814, an absolute-target command 816, and a mixed-mode command 818. The incremental delta-pose command 814 may specify a relative displacement from a current position or pose, such that the UAV 102 moves by a specified offset in one or more axes. The absolute-target command 816 may specify an absolute position or pose in a world coordinate frame or other reference frame, such that the UAV 102 moves to the specified target location. The mixed-mode command 818 may combine incremental and absolute semantics, such that some degrees of freedom are specified incrementally while other degrees of freedom are specified absolutely. In some implementations, the command generation subsystem 146 may select among the incremental delta-pose command 814, the absolute-target command 816, and the mixed-mode command 818 based on the nature of the user input event, the current state of the operator interface 200, or other factors. By way of illustration, a mixed-mode command may include both relative and absolute components, such as specifying an absolute position in one dimension while applying a relative adjustment in another dimension. These examples are provided for explanatory purposes, and other formulations of incremental, absolute, or combined command representations may be used.

The target position may be defined in an absolute coordinate frame or relative to a current position of the UAV. In relative embodiments, the target position may be computed by applying a displacement to the current position. In absolute embodiments, the target position may correspond to a fixed coordinate within a global or local reference frame.

As further shown in FIG. 8, a confirmation-mechanisms region 820 may illustrate a plurality of confirmation approaches that may be employed before a command is transmitted to the UAV 102. The confirmation-mechanisms region 820 may include a confirm-before-send prompt 822, a hold-to-confirm input 824, and a risk-conditioned confirmation state 826. The confirm-before-send prompt 822 may present a dialog, button, or other user-interface element that requires explicit operator confirmation before a previewed command is transmitted. The hold-to-confirm input 824 may require the operator to maintain a key press, button press, or other input for a threshold duration before the command is transmitted. The risk-conditioned confirmation state 826 may invoke confirmation selectively based on characteristics of the proposed movement. In some implementations, the risk-conditioned confirmation state 826 may require confirmation when a movement distance exceeds a threshold, when a movement would bring the UAV 102 near a geofence boundary, or when a movement implicates another operational constraint defined in the operating-limits set 728.

With continued reference to FIG. 8, a queueing-policies region 828 may illustrate a plurality of policies governing how newly received inputs interact with previously issued but not yet converged commands. The queueing-policies region 828 may include a replace policy 830, an append policy 832, and a merge or coalesce policy 834. The replace policy 830 may cause a newly received input to supersede a previously issued command that has not yet converged, such that the UAV 102 abandons the prior commanded position and moves toward the newly commanded position. The append policy 832 may cause a newly received input to be queued for execution after a previously issued command converges, such that the UAV 102 completes the prior movement before beginning the newly commanded movement. The merge or coalesce policy 834 may cause a newly received input to be combined with a previously issued command, such that the resulting commanded position reflects a combination of the prior and new inputs. By way of illustration, under a merge or coalesce policy, multiple commands may be combined into a single resulting command, for example by aggregating displacements or reconciling target positions, thereby reducing intermediate movements. These examples are illustrative, and other queueing behaviors consistent with replacing, appending, or combining commands may be employed. In some embodiments, the selection of a queueing policy may depend on a classification of the user input event or an operational mode of the system.

An immediate-send execution mode 836 may define whether commands are issued immediately upon receipt of a commit action or are subject to serialized handling. In some implementations, the immediate-send execution mode 836 may cause the command generation subsystem 146 to transmit a command to the UAV 102 immediately upon receipt of a commit action from the operator. In other implementations, the command generation subsystem 146 may defer transmission until a prior command has converged or until other preconditions are satisfied.

As further shown in FIG. 8, an overlay-variant region 838 may illustrate variations of overlay elements that may be rendered within the video viewport 202. The overlay-variant region 838 may include an uncertainty ring 840, a minimalist layout 842, and an expanded-control layout 844. The uncertainty ring 840 may be rendered around the current-state marker 206 or the commanded-state marker 208 to indicate positional uncertainty, telemetry confidence, or other state-estimation characteristics. In some implementations, the uncertainty ring 840 may expand or contract based on the estimated accuracy of the telemetry data received from the UAV 102.

The minimalist layout 842 may present a reduced set of overlay elements within the video viewport 202, such that the operator interface 200 displays the current-state marker 206 and the commanded-state marker 208 without additional controls or indicators. The minimalist layout 842 may be suitable for operators who prefer an uncluttered display or for operating conditions in which screen space is limited. The expanded-control layout 844 may present an augmented set of overlay elements within the video viewport 202, such that the operator interface 200 displays additional controls, indicators, or information panels alongside the current-state marker 206 and the commanded-state marker 208. The expanded-control layout 844 may be suitable for operators who prefer access to additional information or controls during precision teleoperation.

The alternative embodiments sheet 800 may thereby demonstrate that the disclosed precision teleoperation system 100 may employ any one or more of the illustrated alternatives alone or in combination. The marker shapes shown in the marker-family region 802, the command types shown in the command-primitives region 812, the confirmation approaches shown in the confirmation-mechanisms region 820, the queueing policies shown in the queueing-policies region 828, and the overlay variations shown in the overlay-variant region 838 may be selected and combined based on operator preferences, operational requirements, or other factors while retaining the disclosed concepts of predictive visualization, explicit distinction between current and intended states, and precision-oriented stepwise movement control.

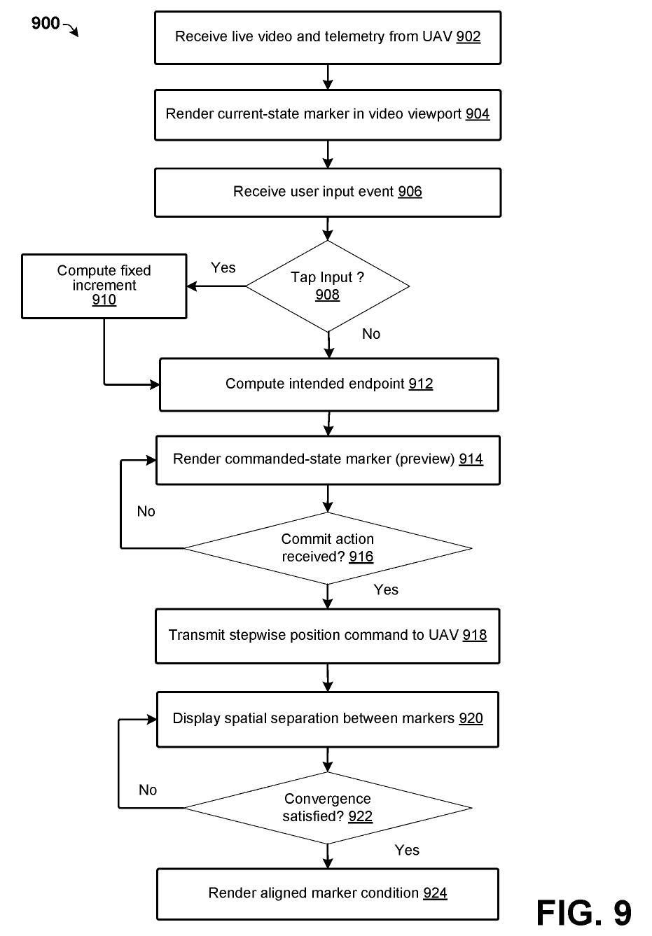

Referring to FIG. 9, a method 900 for controlling an unmanned aerial vehicle via a web-based interface may be performed. At step 902, the operator station 106 may receive live video and telemetry data from the UAV 102 over a network link subject to a latency condition. At step 904, the operator station 106 may render a current-state marker representing the current position of the UAV 102 within a video viewport. At step 906, the operator station 106 may receive a user input event from at least one of a keyboard input device or a pointing input device. At step 908, the operator station 106 may classify the user input event as a tap input or a press input. If the user input event is classified as a tap input, the method 900 may proceed to step 910, where the operator station 106 may compute a fixed movement increment based on a stored user setting. If the user input event is not classified as a tap input, the method 900 may bypass step 910. At step 912, the operator station 106 may compute an intended endpoint based on the user input event. At step 914, the operator station 106 may render a commanded-state marker representing the intended endpoint within the video viewport as a preview overlay. At step 916, the operator station 106 may determine whether a commit action has been received. If the commit action has not been received, the method 900 may return to step 914 to continue displaying the preview. If the commit action has been received, the method 900 may proceed to step 918, where the operator station 106 may transmit a stepwise position command corresponding to the intended endpoint to the UAV 102. At step 920, the operator station 106 may display spatial separation between the current-state marker and the commanded-state marker to indicate a lag condition. At step 922, the operator station 106 may evaluate whether a convergence condition has been satisfied between the current-state marker and the commanded-state marker. If the convergence condition has not been satisfied, the method 900 may return to step 920 to continue displaying the lag condition. If the convergence condition has been satisfied, the method 900 may proceed to step 924, where the operator station 106 may render an aligned marker condition indicating that the UAV 102 has reached the intended endpoint.

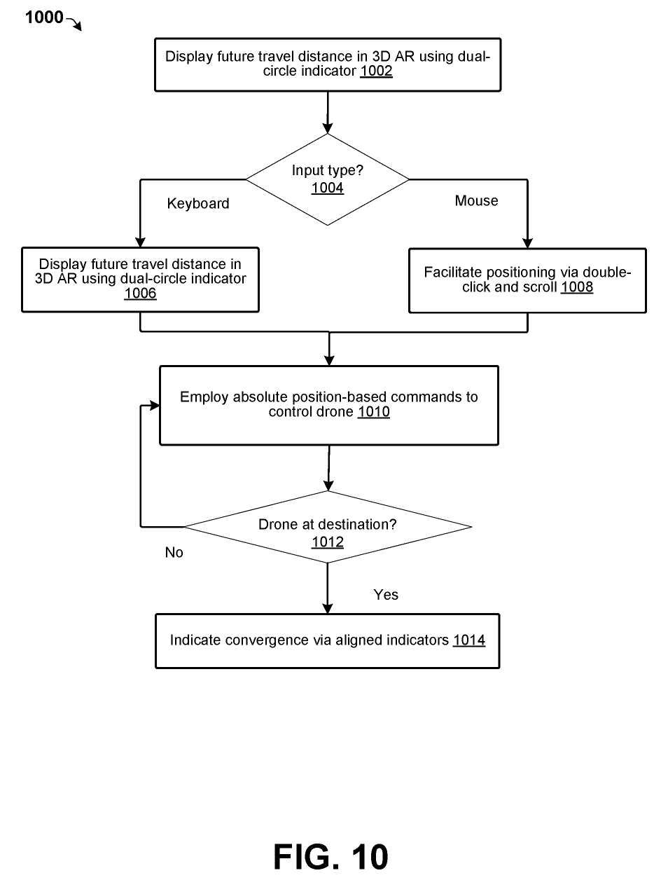

Referring to FIG. 10, a method 1000 for controlling a drone using a web-based interface may be performed. At step 1002, the system may display the drone's future travel distance and final position in a 3D augmented reality environment using a dual-circle indicator system including a smaller circle representing the drone's current position and a larger circle showing the drone's intended destination. At step 1004, the system may determine the input type received from the operator. If the input is a keyboard input, the method 1000 may proceed to step 1006, where the system may initiate a drone movement of a fixed, adjustable distance in response to a keyboard tap. If the input is a mouse input, the method 1000 may bypass step 1006. At step 1008, the system may facilitate precise drone positioning via a mouse-based control system providing fine-tuning adjustments to the drone's position via scroll controls and fixed-distance travel in a direction indicated by a double-click action. At step 1010, the system may employ absolute position-based commands to control the drone. At step 1012, the system may evaluate whether the drone has reached the intended destination. If the drone has not reached the destination, the method 1000 may return to step 1010 to continue monitoring. If the drone has reached the destination, the method 1000 may proceed to step 1014, where the system may indicate convergence via aligned dual-circle indicators.

In some embodiments, mouse input events may be classified as discrete input events or sustained input events. For example, a double-click within a rendered scene may be treated as a discrete input event and may result in determination of a target position corresponding to a selected location within the scene. The selected location may be mapped to a spatial position for the UAV based on a projection, depth estimation, or other mapping between image space and a coordinate frame associated with the UAV.

In some implementations, sustained pointer interactions, such as click-and-drag or continuous pointer movement, may be used to adjust a target position or define a trajectory of successive target positions. In certain embodiments, scroll input associated with a pointing device may be used to adjust a depth component or magnitude of displacement associated with a selected location, thereby refining the target position.

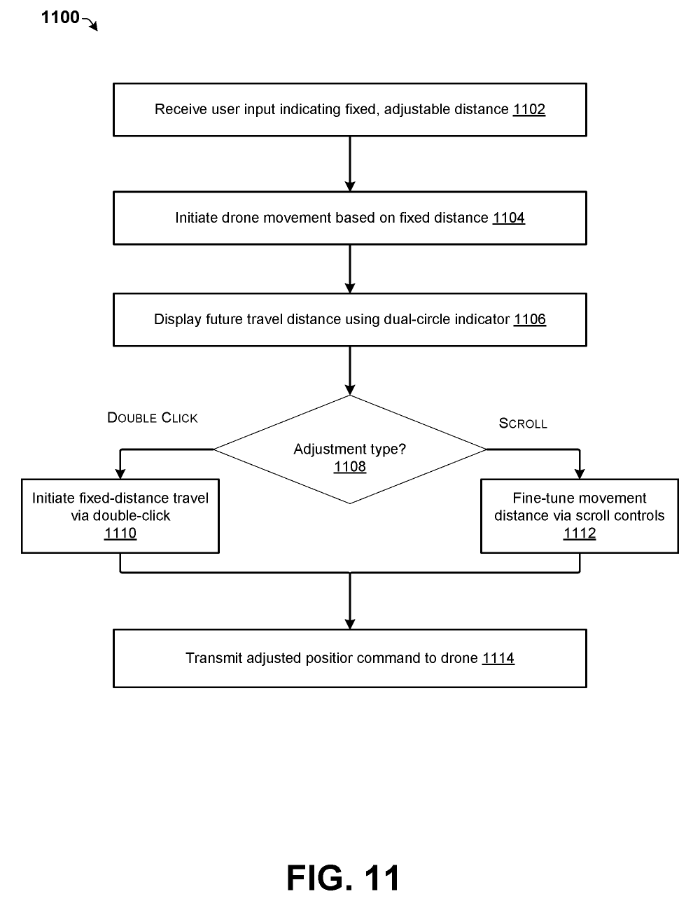

Referring to FIG. 11, a method 1100 for controlling a drone using a web-based interface via an absolute position-based control system may be performed. At step 1102, the system may receive a user input indicating a fixed, adjustable distance for a drone movement. At step 1104, the system may initiate the drone movement based on the fixed, adjustable distance. At step 1106, the system may display the drone's future travel distance and final position using a dual-circle indicator system, wherein a first circle represents the drone's current position and a second circle represents the drone's intended destination. At step 1108, the system may determine the positioning adjustment type. If the adjustment is a double-click action, the method 1100 may proceed to step 1110, where the system may initiate fixed-distance travel in a direction indicated by the double-click action. If the adjustment is a scroll input, the method 1100 may bypass step 1110. At step 1112, the system may fine-tune the movement distance via scroll controls. At step 1114, the system may transmit the adjusted position command to the drone.

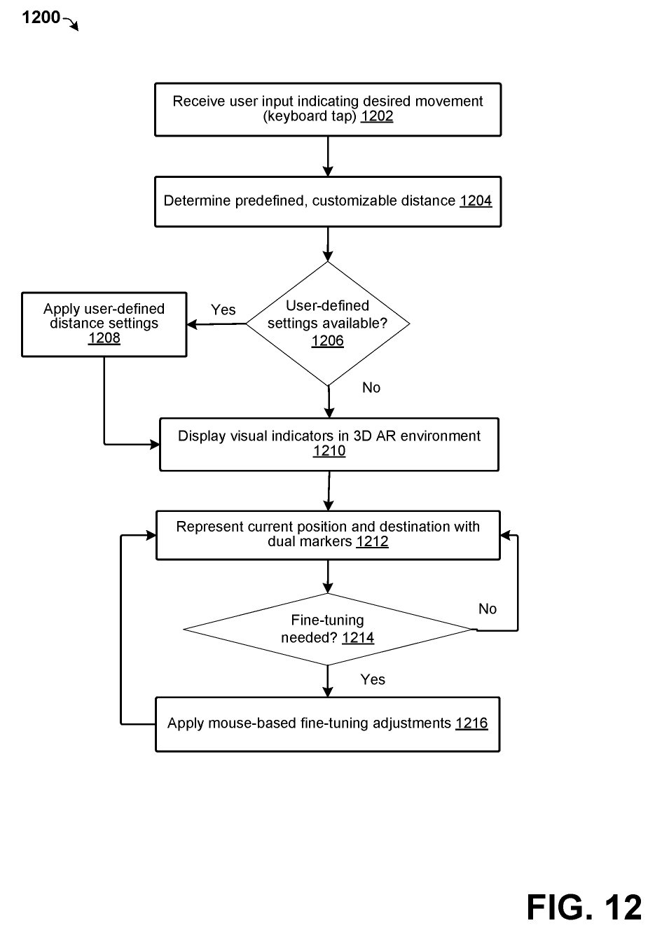

Referring to FIG. 12, a method 1200 for controlling a drone using a web-based interface may be performed. At step 1202, the system may receive a user input indicating a desired movement of the drone, wherein the user input is a keyboard tap. At step 1204, the system may determine a predefined, customizable distance for the desired movement of the drone based on the keyboard tap. At step 1206, the system may evaluate whether user-defined distance settings are available. If user-defined settings are available, the method 1200 may proceed to step 1208, where the system may apply the user-defined distance settings. If user-defined settings are not available, the method 1200 may bypass step 1208 and proceed with a default distance. At step 1210, the system may display visual indicators representing the drone's projected path and destination in a 3D augmented reality environment. At step 1212, the system may represent the drone's current position with a first visual marker and the drone's intended destination with a second visual marker, wherein the first visual marker is smaller than the second visual marker. At step 1214, the system may evaluate whether fine-tuning of the position is needed. If fine-tuning is not needed, the method 1200 may conclude. If fine-tuning is needed, the method 1200 may proceed to step 1216, where the system may apply mouse-based fine-tuning adjustments including fixed-distance travel via a double-click action and position adjustments via scroll controls, and the method 1200 may return to step 1212 to update the dual-marker representation.

In some implementations, execution of a position-based command is decoupled from continued user interaction, such that the UAV proceeds toward a defined target position without requiring sustained input once the command has been generated.

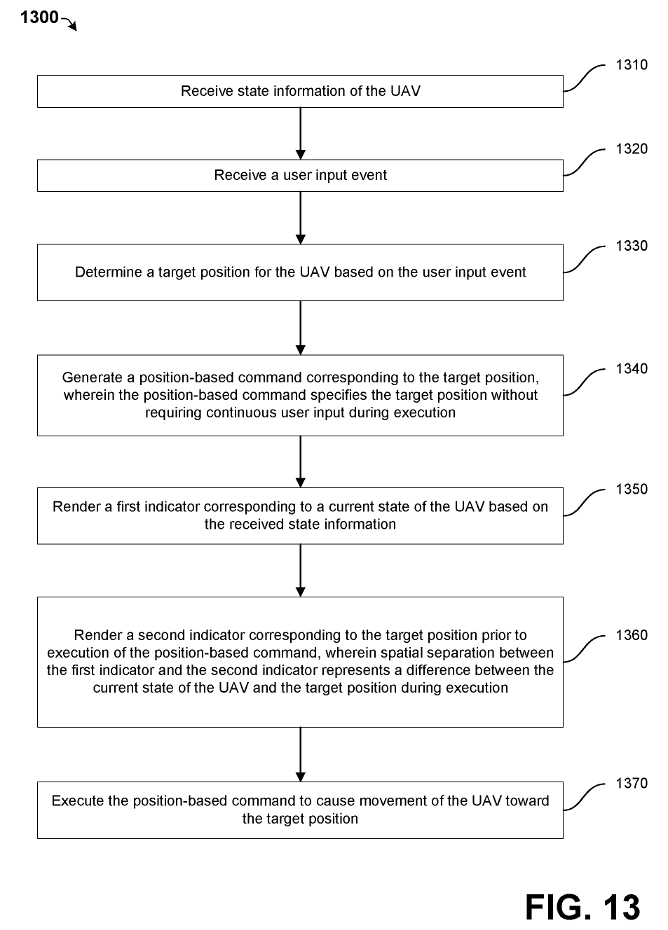

FIG. 13 illustrates a flow diagram of a method 1300 for controlling an UAV using position-based command generation and predictive visualization, consistent with various embodiments.

At block 1310, state information of the UAV 102 may be received, for example, by an operator station 106 via a telemetry interface 150. The state information (e.g., telemetry data 124) may include one or more parameters indicative of a current physical state of the UAV, such as position, orientation, velocity, altitude, or other sensor-derived data. In some embodiments, the state information may be obtained from onboard subsystems of the UAV 102, including a flight control subsystem 112 and a sensor subsystem 116 having, for example, a GNSS receiver, an IMU, a barometer, and one or more cameras.

The received state information may be transmitted over a communication link 104 that may be subject to latency, and may therefore represent a delayed or estimated state of the UAV 102. In some implementations, the state information may be filtered, fused, or otherwise processed prior to use. The state information may be used to determine a current state of the UAV 102 for purposes of visualization and control.

At block 1320, a user input event may be received, for example, by an input handling subsystem 144 of the operator station 106. The user input event may be generated using one or more input devices, such as a keyboard, pointing device, touch interface, or other human-machine interface.

In some embodiments, the input handling subsystem 144 may classify the user input event based on one or more characteristics, such as duration or input modality. For example, the user input event may be classified as a discrete input event or a sustained input event. Discrete input events may include short-duration activations, such as taps or brief key presses, while sustained input events may include prolonged activations, such as continuous key presses or pointer interactions. In some implementations, classification between discrete and sustained input events may be based on a duration of the input relative to a threshold. For example, an input having a duration less than a predefined threshold may be classified as a discrete input event (e.g., a tap of a key on keyboard), while an input having a duration greater than the threshold may be classified as a sustained input event (e.g., keyboard key pressed for a specified duration). In certain embodiments, the classification may additionally or alternatively consider a rate of repeated inputs, a change in input state over time, or other temporal characteristics of the input signal. The classification of the user input event may influence subsequent command generation behavior.

At block 1330, a target position for the UAV 102, which is an intended location or endpoint that the operator would like the UAV 102 to move to, may be determined based on the class or category of the user input event. The determination may be performed by a command generation subsystem 146 of the operator station 106.

In some embodiments, the target position may be determined by applying a displacement to a current position of the UAV. The displacement may be defined by a direction and a magnitude, where the direction may be derived from the user input event and the magnitude may be predefined, user-configurable, or dynamically adjusted.

In certain implementations, the manner in which the target position is determined may depend on a classification of the user input event. For example, in response to a discrete input event, such as a keyboard tap or a mouse double-click, the command generation subsystem 146 may determine a target position corresponding to a predefined displacement or a selected location. A keyboard tap may result in a fixed incremental movement along a corresponding axis or direction, while a mouse double-click within a rendered scene may result in a target position corresponding to a location selected within the scene, mapped to a spatial position for the UAV 102.

In other implementations, in response to a sustained input event, such as a continuous key press or a scroll input, the command generation subsystem may determine one or more target positions based on repeated or accumulated displacements. For example, a continuous key press may result in successive target positions being generated along a given direction, while a scroll input may adjust a magnitude of displacement, such as increasing or decreasing a distance to the target position along a selected direction or depth axis.

In other embodiments, the target position may be determined based on a location selected within a scene rendered by a display subsystem, such as a video viewport 202 displaying imagery captured by the UAV 102, a reconstructed environment, or an augmented or simulated environment. A selected location within the scene may be mapped to a corresponding spatial position for the UAV.

The target position may be defined in an absolute coordinate frame or relative to the current position of the UAV. In some implementations, the target position may be updated based on incremental adjustment inputs, enabling refinement of the target position prior to execution.

At block 1340, a position-based command corresponding to the target position may be generated. The position-based command may define the target position as an intended endpoint for the UAV.

In contrast to control approaches (e.g., velocity-based control) in which motion is directly governed by continuously applied user input, the generated position-based command may specify the target position such that execution of the command proceeds toward the defined endpoint without requiring continuous user input during execution. While characteristics of the user input event, such as duration, may influence how and when commands are generated, each generated command may be independently executable.

In some embodiments, the position-based command may correspond to an incremental displacement, an absolute target position, or a combination thereof. In some implementations, sustained input events may result in generation of successive position-based commands corresponding to updated target positions. In certain implementations, multiple commands may be managed according to one or more queueing policies, such as replacing a previously generated command, appending to a sequence of commands, or merging multiple commands into a combined command.

At block 1350, a first indicator (e.g., current-state marker 206) corresponding to a current state of the UAV 102 may be rendered, for example, by a display subsystem of the operator station 106. The first indicator may be based on the received state information and may represent a telemetry-derived estimate of the current state of the UAV 102. The first indicator may be rendered within a scene, such as a video viewport or other visualization environment, and may be updated as new state information is received.

At block 1360, a second indicator (e.g., commanded-state marker 208) corresponding to the target position may be rendered prior to execution of the position-based command. The second indicator may represent a commanded or predicted state associated with the generated command.

In some embodiments, rendering of the second indicator prior to execution may provide a preview representation of the intended movement of the UAV 102. Execution of the position-based command may be initiated in response to a discrete commit action, thereby decoupling preview from execution and allowing a user to evaluate the intended movement before initiating UAV motion.

During execution of the position-based command, a spatial separation between the first indicator and the second indicator may represent a difference between the current state of the UAV 102 and the target position. The spatial separation may provide a visual indication of system lag, delay, or state error.

At block 1370, the position-based command may be executed to cause movement of the UAV 102 toward the target position. Execution may be performed by the UAV 102, for example, via a flight control subsystem 112 configured to adjust propulsion, orientation, or other actuation parameters to reduce a difference between the current state and the target position.

Execution of the position-based command may proceed without requiring continued user input. In some implementations, execution may occur over a communication link 104 subject to latency. Because the position-based command specifies a target position rather than a rate of motion, execution may be independent of variation in communication delay.

As execution progresses, updated state information may be received and used to update the first indicator. The current state of the UAV may converge toward the target position, and a convergence condition may be satisfied when a difference between the current state and the target position falls within a predefined threshold. In response, an indication of alignment between the first indicator and the second indicator may be rendered.

The method 1300 may thereby enable control of the UAV 102 using position-based commands with predictive visualization of current and target states, facilitating operation under conditions of variable latency.

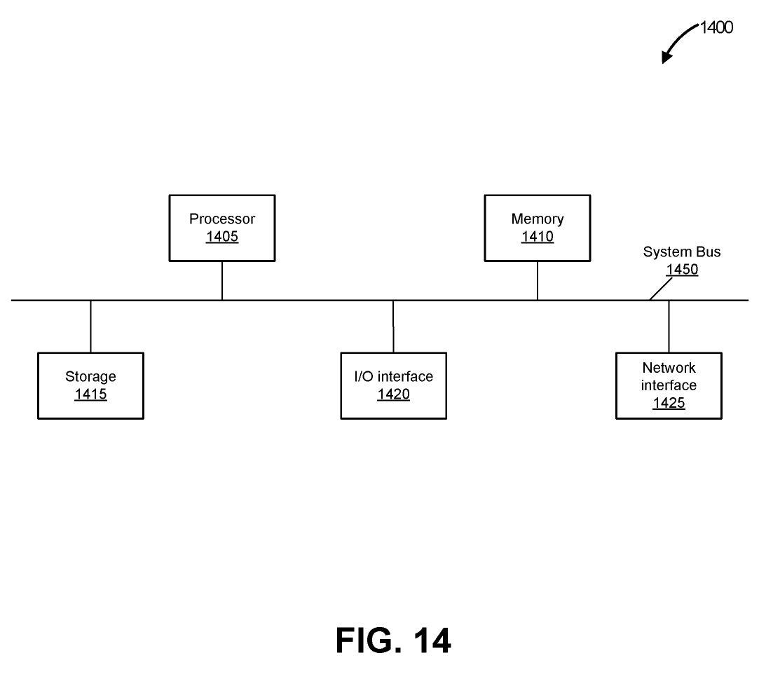

FIG. 14 is a block diagram of a computer system as may be used to implement features of the disclosed embodiments. The generic computer architecture 1400 may include a processor 1405, volatile memory 1410, nonvolatile storage 1415, a network interface 1425, an input/output interface 1420, and a system bus 1450 coupling such components. The generic computer architecture 1400 may correspond to an onboard UAV computing platform, an operator-station client device, or another computing device that executes instructions for performing any of the disclosed methods.

The processor 1405 may be a microprocessor or other processing device configured to execute instructions stored in volatile memory 1410 or nonvolatile storage 1415. The volatile memory 1410 may include random access memory (RAM), dynamic RAM (DRAM), or static RAM (SRAM). The nonvolatile storage 1415 may include one or more magnetic disk storage devices, solid-state drives, flash memory, or optical disks. The processor 1405 may execute instructions to render overlays, classify user inputs, compute intended endpoints, generate commands, synchronize telemetry and video, or perform other disclosed functionality.

The network interface 1425 may permit communication over one or more wired or wireless links. The network interface 1425 may include a modem, network interface card, or other interface for coupling the generic computer architecture 1400 to other computer systems or to the network link 104. The input/output interface 1420 may receive keyboard, mouse, pointing, or other user inputs and may provide output to a display device. The display device may include a liquid crystal display (LCD), cathode ray tube (CRT), or another display device. The system bus 1450 may couple the processor 1405 to the volatile memory 1410, the nonvolatile storage 1415, the network interface 1425, the input/output interface 1420, and the display device.

The generic computer architecture 1400 may operate as a standalone device or may be connected to other machines in a networked deployment. In a networked deployment, the generic computer architecture 1400 may operate as a server or a client machine in a client-server network environment or as a peer machine in a peer-to-peer network environment. The generic computer architecture 1400 may be implemented as a server computer, a client computer, a personal computer, a tablet computer, a laptop computer, or another machine capable of executing a set of instructions that specify actions to be taken by that machine. The generic computer architecture 1400 may thereby provide structural support for processor-executed implementations both onboard the UAV 102 and offboard at the operator station 106.

A number of implementations have been described. Nevertheless, it will be understood that various modifications may be made without departing from the spirit and scope of the disclosure. Accordingly, other implementations are within the scope of the following claims.

The present techniques will be better understood with reference to the following enumerated embodiments.

Clause 1. A system for precision teleoperation of an unmanned aerial vehicle (UAV), the system comprising:
an operator station configured to execute a browser application, the operator station comprising:
   a live video renderer configured to display video frames received from the UAV within a video viewport; an overlay renderer configured to render, within the video viewport:
      a current-state marker representing a current position or viewing state of the UAV derived from received telemetry; and
      a commanded-state marker representing an intended position or viewing state selected by an operator;
      an input handling subsystem configured to receive input events from at least one of a keyboard input device or a pointing input device; and
      a command generation subsystem configured to generate stepwise position commands based on the received input events for transmission to the UAV;
      wherein the overlay renderer is configured to render the current-state marker and the commanded-state marker such that spatial separation between the current-state marker and the commanded-state marker indicates a lag condition between a reported UAV state and a commanded UAV state.

Clause 2. The system of clause 1, wherein the command generation subsystem is configured to generate absolute-position-based commands rather than velocity-based commands.

Clause 3. The system of clause 1, wherein the input handling subsystem is configured to discriminate between a tap input and a press input received from the keyboard input device, and wherein the command generation subsystem is configured to generate a fixed-distance movement command in response to the tap input.

Clause 4. The system of clause 3, further comprising a user settings store configured to store a user-selectable movement increment, wherein the command generation subsystem is configured to compute the fixed-distance movement command based on the user-selectable movement increment.

Clause 5. The system of clause 1, wherein the overlay renderer is further configured to render a preview overlay representing an intended movement before an associated command is transmitted to the UAV.

Clause 6. The system of clause 1, wherein the input handling subsystem is configured to receive a double-click action from the pointing input device, and wherein the command generation subsystem is configured to generate a fixed-distance travel command in a direction indicated by the double-click action.

Clause 7. The system of clause 6, wherein the input handling subsystem is further configured to receive a scroll input from the pointing input device, and wherein the command generation subsystem is configured to adjust a movement distance based on the scroll input.

Clause 8. The system of clause 1, wherein the current-state marker is smaller than the commanded-state marker such that the operator can distinguish the current position from the intended position.

Clause 9. The system of clause 1, wherein the overlay renderer is configured to render an aligned marker condition when the current-state marker and the commanded-state marker become substantially coincident, the aligned marker condition indicating that the UAV has reached the intended position.

Clause 10. A method for controlling an unmanned aerial vehicle (UAV) via a web-based interface, the method comprising:
receiving, at an operator station, live video and telemetry data from the UAV over a network link subject to a latency condition;
rendering, within a video viewport displaying the live video, a current-state marker representing a current position of the UAV derived from the received telemetry data;
receiving a user input event from at least one of a keyboard input device or a pointing input device;
computing an intended endpoint based on the user input event;
rendering, within the video viewport, a commanded-state marker representing the intended endpoint;
transmitting a stepwise position command corresponding to the intended endpoint to the UAV; and
displaying spatial separation between the current-state marker and the commanded-state marker to indicate a lag condition until the current position converges to the intended endpoint.

Clause 11. The method of clause 10, further comprising:
classifying the user input event as a tap input or a press input based on an input duration; and
in response to classifying the user input event as the tap input, computing a fixed movement increment based on a stored user setting.

Clause 12. The method of clause 10, further comprising:
rendering a preview overlay showing the intended endpoint before transmitting the stepwise position command; and
transmitting the stepwise position command in response to receiving a commit action.

Clause 13. The method of clause 10, further comprising:
receiving updated telemetry data from the UAV;
evaluating whether a convergence condition has been satisfied between the current-state marker and the commanded-state marker; and
in response to the convergence condition being satisfied, rendering an aligned marker condition indicating that the UAV has reached the intended endpoint.

Clause 14. The method of clause 10, wherein receiving the user input event comprises receiving a double-click action from the pointing input device, and wherein computing the intended endpoint comprises determining a fixed-distance travel in a direction indicated by the double-click action.

Clause 15. The method of clause 14, further comprising:
receiving a scroll input from the pointing input device; and
adjusting a movement distance associated with the intended endpoint based on the scroll input.

Clause 16. The method of clause 10, further comprising:
detecting a degraded link condition based on at least one of telemetry freshness, latency exceeding a threshold, or packet loss exceeding a threshold; and
in response to detecting the degraded link condition, rendering a warning indicator within the video viewport.

Clause 17. A non-transitory computer-readable medium storing instructions that, when executed by a processor, cause the processor to perform operations comprising:
receiving live video and telemetry data from an unmanned aerial vehicle (UAV) over a network link;
rendering, within a video viewport displaying the live video, a current-state marker representing a current position of the UAV;
receiving a user input event;
computing an intended endpoint based on the user input event;
rendering, within the video viewport, a commanded-state marker representing the intended endpoint, wherein the current-state marker and the commanded-state marker are rendered such that spatial separation between the markers indicates a lag condition;
generating a stepwise position command corresponding to the intended endpoint; and
transmitting the stepwise position command to the UAV.

Clause 18. The non-transitory computer-readable medium of clause 17, wherein the operations further comprise:
discriminating between a tap input and a press input based on an input duration of the user input event; and in response to the user input event being classified as the tap input, computing a fixed movement increment based on a user-configurable distance setting.

Clause 19. The non-transitory computer-readable medium of clause 17, wherein the operations further comprise:
rendering a preview overlay representing the intended endpoint before the stepwise position command is transmitted;
receiving updated telemetry data indicating an updated current position of the UAV; and
rendering an aligned marker condition when the updated current position converges to the intended endpoint.

Clause 20. The non-transitory computer-readable medium of clause 17, wherein the user input event comprises a double-click action from a pointing input device, and wherein computing the intended endpoint comprises determining a fixed-distance travel in a direction indicated by the double-click action, and wherein the operations further comprise adjusting a movement distance based on a scroll input received from the pointing input device.

Clause 21. A web-based drone control system, comprising:
a visual position indicator system configured to display a drone's future travel distance and final position in a 3D augmented reality environment before the drone executes a movement, the visual position indicator system comprising a dual-circle indicator system including a smaller circle representing the drone's current position and a larger circle showing the drone's intended destination;
a mouse-based control system configured to facilitate precise drone positioning despite latency, the mouse-based control system providing fine-tuning adjustments to the drone's position via scroll controls and fixed-distance travel in a direction indicated by a double-click action;
a differentiated keyboard input system configured to initiate a drone movement of a fixed, adjustable distance in response to a keyboard tap; and
an absolute position-based interface configured to employ absolute position-based commands to control the drone.

Clause 22. The web-based drone control system of clause 21, wherein the visual position indicator system is configured to enhance spatial awareness and predictive control accuracy of the drone.

Clause 23. The web-based drone control system of clause 21, wherein the visual position indicator system is configured to provide an augmented reality indication of where the drone is going to move in response to a particular user interaction.

Clause 24. The web-based drone control system of clause 21, wherein the mouse-based control system is configured to provide precise drone positioning despite latency.

Clause 25. The web-based drone control system of clause 21, wherein the differentiated keyboard input system is configured to enable predictable and precise increments of drone movement.

Clause 26. The web-based drone control system of clause 21, further comprising user-defined settings configured to define the fixed, adjustable distance for the keyboard tap.

Clause 27. The web-based drone control system of clause 21, wherein the absolute position-based interface is configured to significantly improve reliability and predictability of drone control compared to velocity-based controls.

Clause 28. A method for controlling a drone using a web-based interface, the method comprising:
displaying, via a visual position indicator system, a drone's future travel distance and final position in a 3D augmented reality environment before the drone executes a movement, the visual position indicator system comprising a dual-circle indicator system including a smaller circle representing the drone's current position and a larger circle showing the drone's intended destination;
facilitating, via a mouse-based control system, precise drone positioning despite latency by providing fine-tuning adjustments to the drone's position via scroll controls and fixed-distance travel in a direction indicated by a double-click action;
initiating, via a differentiated keyboard input system, a drone movement of a fixed, adjustable distance in response to a keyboard tap; and
employing, via an absolute position-based interface, absolute position-based commands to control the drone.

Clause 29. The method of clause 28, further comprising enhancing spatial awareness and predictive control accuracy of the drone via the visual position indicator system.

Clause 30. The method of clause 28, further comprising providing, via the visual position indicator system, an augmented reality indication of where the drone is going to move in response to a particular user interaction.

Clause 31. The method of clause 28, further comprising providing, via the mouse-based control system, precise drone positioning despite latency.

Clause 32. The method of clause 28, further comprising enabling, via the differentiated keyboard input system, predictable and precise increments of drone movement.

Clause 33. The method of clause 28, further comprising defining, via user-defined settings, the fixed, adjustable distance for the keyboard tap.

Clause 34. The method of clause 28, further comprising significantly improving, via the absolute position-based interface, reliability and predictability of drone control compared to velocity-based controls.

Clause 35. A non-transitory computer-readable medium storing instructions that, when executed by a processor, cause the processor to perform operations for controlling a drone using a web-based interface, the operations comprising:
displaying, via a visual position indicator system, a drone's future travel distance and final position in a 3D augmented reality environment before the drone executes a movement, the visual position indicator system comprising a dual-circle indicator system including a smaller circle representing the drone's current position and a larger circle showing the drone's intended destination;
facilitating, via a mouse-based control system, precise drone positioning despite latency by providing fine-tuning adjustments to the drone's position via scroll controls and fixed-distance travel in a direction indicated by a double-click action;
initiating, via a differentiated keyboard input system, a drone movement of a fixed, adjustable distance in response to a keyboard tap; and
employing, via an absolute position-based interface, absolute position-based commands to control the drone.

Clause 36. The non-transitory computer-readable medium of clause 35, wherein the operations further comprise enhancing spatial awareness and predictive control accuracy of the drone via the visual position indicator system.

Clause 37. The non-transitory computer-readable medium of clause 35, wherein the operations further comprise providing, via the visual position indicator system, an augmented reality indication of where the drone is going to move in response to a particular user interaction.

Clause 38. The non-transitory computer-readable medium of clause 35, wherein the operations further comprise providing, via the mouse-based control system, precise drone positioning despite latency.

Clause 39. The non-transitory computer-readable medium of clause 35, wherein the operations further comprise enabling, via the differentiated keyboard input system, predictable and precise increments of drone movement.

Clause 40. The non-transitory computer-readable medium of clause 35, wherein the operations further comprise defining, via user-defined settings, the fixed, adjustable distance for the keyboard tap.

Clause 41. A computer-implemented method for controlling a drone using a web-based interface, the method comprising:
receiving, via an absolute position-based control system, a user input indicating a fixed, adjustable distance for a drone movement;
initiating, by the absolute position-based control system, the drone movement based on the fixed, adjustable distance;
displaying, via an augmented reality predictive visualization system, the drone's future travel distance and final position using a dual-circle indicator system, wherein a first circle represents the drone's current position and a second circle represents the drone's intended destination; and
facilitating, via a precision mouse control system, precise drone positioning using at least one of a double-click action for fixed-distance travel or scroll controls for fine-tuning adjustments.

Clause 42. The method of clause 41, wherein the user input is a keyboard tap.

Clause 43. The method of clause 41, wherein the fixed, adjustable distance is defined by user settings.

Clause 44. The method of clause 41, wherein the augmented reality predictive visualization system displays the drone's future travel distance and final position in a three-dimensional augmented reality environment.

Clause 45. The method of clause 41, wherein the dual-circle indicator system comprises a smaller circle representing the drone's current position and a larger circle representing the drone's intended destination.

Clause 46. The method of clause 41, wherein the absolute position-based control system enables predictable and precise increments in drone control and movement.

Clause 47. The method of clause 41, wherein the augmented reality predictive visualization system enhances spatial awareness, predictive control accuracy, and facilitates precise drone positioning despite latency.

Clause 48. The method of clause 41, wherein the precision mouse control system enables fine-tuning adjustments for precise drone control.

Clause 49. The method of clause 41, further comprising:
receiving, via the precision mouse control system, a double-click action; and
initiating, by the absolute position-based control system, a fixed-distance travel for the drone in a direction indicated by the double-click action.

Clause 50. The method of clause 41, further comprising:
receiving, via the precision mouse control system, a scroll control input; and
adjusting, by the absolute position-based control system, the drone's position based on the scroll control input.

Clause 51. A system for controlling a drone using a web-based interface, the system comprising:
an absolute position-based control system configured to: receive a user input indicating a fixed, adjustable distance for a drone movement; and
initiate the drone movement based on the fixed, adjustable distance;
an augmented reality predictive visualization system configured to display the drone's future travel distance and final position using a dual-circle indicator system, wherein a first circle represents the drone's current position and a second circle represents the drone's intended destination; and
a precision mouse control system configured to facilitate precise drone positioning using at least one of a double-click action for fixed-distance travel or scroll controls for fine-tuning adjustments.

Clause 52. The system of clause 51, wherein the user input is a keyboard tap.

Clause 53. The system of clause 51, wherein the fixed, adjustable distance is defined by user settings.

Clause 54. The system of clause 51, wherein the augmented reality predictive visualization system is configured to display the drone's future travel distance and final position in a three-dimensional augmented reality environment.

Clause 55. The system of clause 51, wherein the dual-circle indicator system comprises a smaller circle representing the drone's current position and a larger circle representing the drone's intended destination.

Clause 56. The system of clause 51, wherein the absolute position-based control system is configured to enable predictable and precise increments in drone control and movement.

Clause 57. The system of clause 51, wherein the augmented reality predictive visualization system is configured to enhance spatial awareness, predictive control accuracy, and facilitate precise drone positioning despite latency.

Clause 58. The system of clause 51, wherein the precision mouse control system is configured to enable fine-tuning adjustments for precise drone control.

Clause 59. The system of clause 51, wherein the precision mouse control system is further configured to:
receive a double-click action; and cause the absolute position-based control system to initiate a fixed-distance travel for the drone in a direction indicated by the double-click action.

Clause 60. The system of clause 51, wherein the precision mouse control system is further configured to:
receive a scroll control input; and
cause the absolute position-based control system to adjust the drone's position based on the scroll control input.

Clause 61. A method for controlling a drone using a web-based interface, the method comprising:
receiving, via the web-based interface, a user input indicating a desired movement of the drone, wherein the user input is a keyboard tap;
determining, based on the keyboard tap, a predefined, customizable distance for the desired movement of the drone;
displaying, in a 3D augmented reality environment of the web-based interface, visual indicators representing the drone's projected path and destination prior to executing the desired movement; and
representing, via a dual-circle indicator system in the web-based interface, the drone's current position with a first visual marker and the drone's intended destination with a second visual marker, wherein the first visual marker is smaller than the second visual marker.

Clause 62. The method of clause 61, wherein the web-based interface further comprises user settings for defining the predefined, customizable distance for the desired movement of the drone.

Clause 63. The method of clause 61, wherein the web-based interface further comprises mouse interactions for enabling fixed-distance travel of the drone in an indicated direction via a double-click action and fine-tuning adjustments of the drone's position via scroll controls.

Clause 64. The method of clause 61, wherein the visual indicators in the 3D augmented reality environment comprise the drone's future travel distance and final position.

Clause 65. The method of clause 61, wherein the dual-circle indicator system facilitates precise drone positioning despite latency.

Clause 66. A system for controlling a drone using a web-based interface, the system comprising:
a user input module configured to receive, via the web-based interface, a user input indicating a desired movement of the drone, wherein the user input is a keyboard tap;
a distance determination module configured to determine, based on the keyboard tap, a predefined, customizable distance for the desired movement of the drone;
a display module configured to display, in a 3D augmented reality environment of the web-based interface, visual indicators representing the drone's projected path and destination prior to executing the desired movement; and
a dual-circle indicator module configured to represent, via a dual-circle indicator system in the web-based interface, the drone's current position with a first visual marker and the drone's intended destination with a second visual marker, wherein the first visual marker is smaller than the second visual marker.

Clause 67. The system of clause 66, wherein the web-based interface further comprises user settings for defining the predefined, customizable distance for the desired movement of the drone.

Clause 68. The system of clause 66, wherein the web-based interface further comprises mouse interactions for enabling fixed-distance travel of the drone in an indicated direction via a double-click action and fine-tuning adjustments of the drone's position via scroll controls.

Clause 69. The system of clause 66, wherein the visual indicators in the 3D augmented reality environment comprise the drone's future travel distance and final position.

Clause 70. The system of clause 66, wherein the dual-circle indicator system facilitates precise drone positioning despite latency.

Clause 71. A non-transitory computer-readable medium storing instructions that, when executed by a processor, cause the processor to perform a method for controlling a drone using a web-based interface, the method comprising:
receiving, via the web-based interface, a user input indicating a desired movement of the drone, wherein the user input is a keyboard tap;
determining, based on the keyboard tap, a predefined, customizable distance for the desired movement of the drone;
displaying, in a 3D augmented reality environment of the web-based interface, visual indicators representing the drone's projected path and destination prior to executing the desired movement; and
representing, via a dual-circle indicator system in the web-based interface, the drone's current position with a first visual marker and the drone's intended destination with a second visual marker, wherein the first visual marker is smaller than the second visual marker.

Clause 72. The non-transitory computer-readable medium of clause 71, wherein the web-based interface further comprises user settings for defining the predefined, customizable distance for the desired movement of the drone.

Clause 73. The non-transitory computer-readable medium of clause 71, wherein the web-based interface further comprises mouse interactions for enabling fixed-distance travel of the drone in an indicated direction via a double-click action and fine-tuning adjustments of the drone's position via scroll controls.

Clause 74. The non-transitory computer-readable medium of clause 71, wherein the visual indicators in the 3D augmented reality environment comprise the drone's future travel distance and final position.

Clause 75. The non-transitory computer-readable medium of clause 71, wherein the dual-circle indicator system facilitates precise drone positioning despite latency.

1. A system for controlling an unmanned aerial vehicle (UAV), the system comprising:
an operator station comprising:
a telemetry interface configured to receive state information of the UAV; and
an input handling subsystem configured to receive user input events;
a command generation subsystem configured to:
determine, based on a user input event, a target position for the UAV; and
generate a position-based command corresponding to the target position; and
a display subsystem configured to:
render a first indicator corresponding to a current state of the UAV based on the received state information; and
render a second indicator corresponding to the target position prior to execution of the position-based command;
wherein the position-based command specifies the target position without requiring continuous user input during execution, and
wherein spatial separation between the first indicator and the second indicator represents a difference between the current state of the UAV and the target position during execution.

2. The system of claim 1, wherein the display subsystem is configured to render a preview representation of the target position prior to execution of the position-based command, and wherein the command generation subsystem is configured to initiate execution of the position-based command in response to a discrete commit action separate from generation of the preview representation.

3. The system of claim 1, wherein:
the input handling subsystem is configured to classify a user input event as discrete or continuous; and
the command generation subsystem is configured to generate, in response to a first class of input events, a fixed-distance movement command corresponding to a predefined displacement magnitude.

4. The system of claim 1, wherein:
the input handling subsystem is configured to receive a directional input; and
the command generation subsystem is configured to determine the target position based on the directional input and a predefined displacement magnitude.

5. The system of claim 1, wherein the target position is determined based on a location selected within a scene rendered by the display subsystem.

6. The system of claim 1, wherein the command generation subsystem is configured to update the target position based on incremental adjustment inputs.

7. The system of claim 1, wherein:
the system is configured to operate over a communication link subject to latency; and
execution of the position-based command is independent of variation in communication delay.

8. The system of claim 1, wherein:
the telemetry interface is configured to receive updated state information of the UAV during execution of the position-based command; and
the display subsystem is configured to:
update the first indicator based on the updated state information; and
render an indication of alignment when the current state satisfies a convergence criterion relative to the target position.

9. A method for controlling an unmanned aerial vehicle (UAV), the method comprising:
receiving state information of the UAV;
receiving a user input event;
determining, based on the user input event, a target position for the UAV;
generating a position-based command corresponding to the target position, wherein the position-based command specifies the target position without requiring continuous user input during execution;
rendering a first indicator corresponding to a current state of the UAV based on the received state information;
rendering a second indicator corresponding to the target position prior to execution of the position-based command, wherein spatial separation between the first indicator and the second indicator represents a difference between the current state of the UAV based on the received state information and the target position during execution; and
executing the position-based command to cause movement of the UAV toward the target position.

10. The method of claim 9, wherein executing the position-based command includes:
initiating execution of the position-based command in response to a discrete commit action; and
rendering a preview representation of the target position prior to the discrete commit action.

11. The method of claim 9 further comprising:
classifying the user input event based on whether the user input event is discrete or continuous; and
generating, in response to a first class of input events, a fixed-distance movement command corresponding to a predefined displacement magnitude.

12. The method of claim 9 further comprising:
receiving a directional input; and
determining the target position based on the directional input and a predefined displacement magnitude.

13. The method of claim 9, wherein determining the target position comprises:
determining the target position based on a location selected within a scene rendered for display.

14. The method of claim 9 further comprising:
updating the target position based on incremental adjustment inputs.

15. The method of claim 9, wherein execution of the position-based command is independent of variation in communication delay of a communication link used to communicate the position-based command.

16. The method of claim 9 further comprising:
receiving updated state information of the UAV during execution of the position-based command;
updating the first indicator based on the updated state information; and
rendering an indication of alignment when the current state satisfies a convergence criterion relative to the target position.

17. A non-transitory computer-readable medium storing instructions that, when executed by one or more processors, cause the one or more processors to:
receive state information of an unmanned aerial vehicle (UAV);
receive a user input event;
determine, based on the user input event, a target position for the UAV;
generate a position-based command corresponding to the target position, wherein the position-based command specifies the target position without requiring continuous user input during execution;
execute the position-based command to cause movement of the UAV toward the target position;
render a first indicator corresponding to a current state of the UAV based on the received state information; and
render a second indicator corresponding to the target position prior to execution of the position-based command, wherein spatial separation between the first indicator and the second indicator represents a difference between the current state of the UAV based on the received state information and the target position during execution.

18. The non-transitory computer-readable medium of claim 17, wherein the instructions further cause the one or more processors to:
render a preview representation of the target position prior to execution of the position-based command; and
initiate execution of the position-based command in response to a discrete commit action separate from generation of the preview representation.

19. The non-transitory computer-readable medium of claim 17, wherein the instructions further cause the one or more processors to:
classify the user input event based on whether the user input event is discrete or continuous; and
generate, in response to a first class of input events, a fixed-distance movement command corresponding to a predefined displacement magnitude.

20. The non-transitory computer-readable medium of claim 17, wherein execution of the position-based command is independent of variation in communication delay of a communication link used to communicate the position-based command.
